(19) United States
(12) Patent Application Publication
(10) Pub. No.: US 2023/0118380 A1
(43) Pub. Date: Apr. 20, 2023

(54) Systems And Methods For Monitoring, Analyzing and Regulating Blockchain Transactions

(71) Applicants: Oceidon Corporation, Road Town (VG); Etherstone Inc., Mississauga (CA)

(72) Inventor: Jacek Krosinski, Mississauga (CA)

(21) Appl. No.: 17/725,901

(22) Filed: Apr. 21, 2022

Related U.S. Application Data
(60) Provisional application No. 63/256,895, filed on Oct. 18, 2021.

(51) Int. Cl. G06Q 20/40; G06Q 20/38

(52) U.S. Cl. CPC G06Q 20/4014; G06Q 20/389

(57) ABSTRACT

Systems and methods for generating a metric based on blockchain data for use in controlling, evaluating, or otherwise regulating a transaction. The metric may be used to control the release of assets, to trigger an event, or as a measure of the satisfaction of contractual conditions based on whether the characteristics of a transaction or of a party engaging in a transaction are associated with a score that satisfies a threshold value. In some embodiments, a state-change derived score or metric allows the creation of a layer of trust or reliability that a blockchain network can reference in situations where a greater degree of trust is desired.

### CROSS REFERENCE TO RELATED APPLICATION

This application claims the benefit of U.S. Provisional Application No. 63/256,895, entitled “Systems And Methods For Monitoring and Regulating Blockchain Interactions,” filed Oct. 18, 2021, the disclosure of which is incorporated, in its entirety (including the Appendix) by this reference.

### BACKGROUND

A blockchain is a decentralized, distributed, and oftentimes public, digital ledger consisting of records called blocks and is used to record transactions across multiple computers. One feature of a blockchain is that any involved block cannot be altered retroactively, without the alteration of all subsequent blocks. This allows the participants to verify and audit transactions independently and inexpensively in terms of the resources required. Blockchains allow secure, distributed storage of event and transaction data that is verifiable and resistant to unauthorized usage.

The blocks in a blockchain are interconnected by encrypting data of a previous block in the chain and inserting it into a current block. For example, each block contains a cryptographic hash of the previous block, a time stamp, and exchange information (such as conditions on when a payment will be transferred, or a condition satisfied). A blockchain database is managed autonomously using a peer-to-peer network and a distributed timestamping server. New blocks are authenticated by mass collaboration powered by collective self-interest. This approach facilitates robust workflow and one where participants' uncertainty regarding data security is reduced to an acceptable level to engender sufficient trust to engage in economic transactions. One reason for this is that the use of a blockchain removes the characteristic of infinite reproducibility from a digital asset. It confirms that each unit of value was transferred only once, solving the long-standing problem of double spending.

A blockchain can be used to maintain and exchange title (ownership) rights because, when properly set up to detail an exchange agreement, it provides a record that compels offer and acceptance. It is for this reason, among others, that blockchains are being found as part of “smart” contracts that are largely self-executing while maintaining security and a desired level of trust.

Two popular uses of blockchain are for cryptocurrencies and “smart” contracts. Most cryptocurrencies use blockchain technology to record transactions. For example, the bitcoin network and Ethereum network are both based on blockchain. Blockchain-based smart contracts are proposed contracts that can be partially or fully executed or enforced without human interaction. One of the objectives of a smart contract is automated escrow. A key feature of smart contracts is that they do not need a trusted third party (such as a trustee) to act as an intermediary between contracting entities. Instead, the blockchain network executes the contract on its own. This may reduce friction between entities when transferring value and could subsequently open the door to a higher level of transaction automation.

Logically, a blockchain may be considered to consist of several functions that are implemented as layers:
infrastructure (hardware);
networking (node discovery, information propagation and verification processes); consensus functions (proof of work, proof of stake);
data (blocks, transactions);
applications (smart contracts/decentralized applications, etc.)

However, even though blockchain has become more widely used and is a key enabling technology for cryptocurrency and smart contracts and shows promise for multiple use cases and applications), there remain obstacles to wider adoption. For example, the inherent anonymity of transactions that use a blockchain as a data record can present problems when it is important to be aware of a party's transaction history prior to authorizing an exchange of value or triggering an event. In one example, this may be because a transaction history indicating many short-term purchases and sales of currency may indicate someone attempting to manipulate the market for a currency. Further, in some cases, it may be useful to have a better understanding of how reliable a party to a transaction is before agreeing to an exchange or entering into a smart contract or other form of agreement.

Although the practice of pairing distributed records with a consensus mechanism creates the ability to interact with an unknown party and be guaranteed that terms of the interaction are complied with, what is missing is a method of generating pre-requisites that allow a decision to be made prior to parties attempting the interaction. Despite the nature of blockchain that makes interactions possible without a pre-existing level of trust and enables a successful exchange with other parties, there are many instances where it may be advantageous to qualify an unknown party as to their suitability to interact with.

Embodiments of the systems and methods described herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter described in this document, the drawings or figures, and to the claims, Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments described herein are directed to a system and methods for generating a metric based on blockchain data that may be used to control, evaluate, or otherwise regulate a transaction. The metric, also referred to as a “score”, “index”, or “measure” herein may be used to control the release of assets, as a trigger of an event, or as a measure of the satisfaction of contractual conditions based on whether the characteristics of a transaction or of a party engaging in a transaction are associated with a score that equals or exceeds a predetermined level. In some embodiments, a state-change derived score or metric allows the creation of a layer of trust, of control, of understanding, and reliability that a blockchain (or other type of “trustless”) network can reference in situations where a greater degree of trust in (and/or control of) a process or transaction is desired.

The score or metric may be calculated in different ways and used to control multiple types of events, but in each case it is based (at least partially) on data residing in (or carried on) a blockchain and is used to evaluate the “behavior” of a party to a proposed transaction. In this context, behavior can be considered as reflected by a set of one or more blockchain state changes initiated by an external party. These state changes can be indicative of an intent by the initiating party to achieve a pre-determined result. In some cases, the blockchain state changes may be indicative of the party engaging in a specific and undesirable activity (such as high-velocity trading, purchase of specific types of tokens, purchase of specific types of products or services, etc.). Consequently, embodiments can use the state changes to decide if this intent or type of behavior aligns with the goals of other parties to the possible transaction. Embodiments can also use the state changes to automatically execute logic that can accept or deny a proposed transaction or a term of the transaction.

In some use cases, the disclosed metric may perform a similar function to a credit score used to set interest rates for loans, although as will be described, the disclosed metric offers a greater degree of flexibility with regards to its method of calculation and uses. Because the source of data used to derive the metric is, on the blockchain side, immutable and complete, the metric is a more accurate reflection of an actor, as opposed to the limited scope represented by a credit score. Further, because of the ability to integrate smart contracts and similar executable logic with a blockchain, the disclosed score can be used to facilitate performing functions and processes that cannot be automatically and securely executed by conventional approaches.

For example, a score or metric as described herein can reflect complex data sets such as the performance of a supply chain or the manufacture and distribution of a product. Supply chains that integrate blockchain technology often tokenize off-chain objects (things) and record these tokens on public or private blockchains. Any state change linked to such tokens can be a data point that is used to generate a performance score or metric for purposes of monitoring and evaluating a segment of a supply chain. For example, does a token representing a product move relatively swiftly through the supply chain? Are there movement delays at some point that can be indicative of inefficiencies or a need for correction? In this sense, derived blockchain state change scores can serve as actionable data that is unquestionable as to its authenticity since it was derived from immutable sources.

In the event where state changes are obfuscated via the use of pseudo transactions, walled gardens, transposition or similar methods, external scoring can still be used to assess the obfuscated transactions. A value can be assigned to the action of using obfuscation and incorporated into an overall trust metric. Using human evaluation or machine learning techniques applied to the method of obfuscation being used, one can derive scores based on obfuscated transactions themselves by evaluating recorded data points of the transaction.

Another behavior of concern is that it is possible for an actor to utilize more than one blockchain address and to use each address for different types of transactions. For example, an actor may utilize a “false” address to engage in a transaction so that the address is not associated with a set of previous activities linked to their more commonly used address. This may be intended to evade the impact of a scoring mechanism, or other form of detection.

To counteract this behavior, in one example embodiment, an entity wishing to interact with legitimate addresses can choose to implement a score variant that includes an identification verification component. In this example, only those addresses that are controlled by actors whose identification has been verified are permitted to interact. Even so, there may arise methods of evasion or score manipulation, and the scoring system described may evolve and be adjusted or modified to combat these attempts as they are discovered. For example, as mentioned, one method of dealing with obfuscation is to identify that obfuscation has occurred by flagging transactions that have been done with obfuscating services or chains and assigning them a “Used Obfuscation” score component. This will indicate to the scoring algorithm or methodology that a potentially invalid or otherwise undesirable transaction has been encountered. In some embodiments, the use of obfuscation by an address can be used as a data point that can either positively or negatively impact a score.

In some embodiments, a permission-based mechanism may be employed to allow a party to provide a score generated from publicly hidden transactions to a requestor. In these situations, the party may be able to grant permission to a scoring algorithm or method to access private transactions and generate a private score for the requesting party.

In some use cases, bureaucratic and time intensive processes that depend on the verification of identity can be reduced to a universal one-step score. For example, once a person's identity is verified, that status can be recorded on the blockchain in a binary format as a “1” and linked to that person's declared wallet address (where unverified identities can be assigned a score of 0). For example, blockchain transactions that would normally require a report to a national anti-money laundering agency can be processed without further delay as they are connected to a physical person whose identity is known and has been verified. Conversely, if a person is on a watchlist or their identity has not been verified (as indicated by a score of 0 in the identity metric), then a transaction may be rejected and flagged for further investigation.

In some scenarios, more than a single scoring method may be used in score-based decision making. Multiple score variants (used herein to refer to a specific scoring process) may be applied individually or in combination to arrive at a final score-based decision regarding a particular address. For example, an address that has a high score in a “Quality of Trading” score variant may be very desirable and such score would usually warrant a score gated (i.e., a score controlled) smart contract to permit interaction. However, a secondary score lookup by that same smart contract, that checks the “Use of Obfuscation” score variant, could disqualify that address from interaction regardless of how favorably it scored on the “Quality of Trading” scoring variant.

Embodiments of the system and methods for generating a score or metric based on blockchain data disclosed herein may be used to control or condition multiple types of transactions and agreements. For example, based on a party's previous history of transactions on the blockchain, another party may not want to initiate an exchange of sensitive data with the first party. In such a case, the history of blockchain interactions may indicate one party is an actor that will inappropriately use the data that is provided to them. In this regard, a transaction history may show the use of obfuscation services or interactions with rogue governments, which would preferably result in the party being disqualified from interacting with another party that might be providing confidential or private data. This is but one example of a situation where a party to a proposed transaction needs to be evaluated prior to initiating the transaction.

Another important issue addressed by the disclosed system and methods is that of privacy when conducting online transactions, such as payments during an eCommerce transaction. In this regard, embodiments can add a layer of privacy protection previously unavailable, where this can be described as Zero Knowledge Proof of Identity (ZKPI) Verification. Data and identity privacy is of great concern in publicly visible instances of the blockchain. At the same time there is a need to verify the identity of block chain participants in many types of transactions or interactions. Embodiments of the proposed scoring system allow for both privacy and identity confirmation to co-exist and interact.

As an example of this capability or implementation of the disclosed methods, a trusted identity verifier such as a government service, specialized private sector entity, or a zero-knowledge-proof (ZKP) algorithmic verification method may be used to verify the identity of an entity that is linked to a blockchain address. The entity linked to the blockchain could be a physical person, a corporation, a computer process, or a smart contract, as examples. Once the entity's identity was verified, the verified status would be recorded as a Boolean record or data item on the blockchain. This record would serve as a data source and be used by the proposed scoring system to return a score based on the data source. For example, the data might be recorded as Identity verified=1 (True) or Identity not verified=0 (False).

Note that at no time does the requestor of an Identity Verified status need to know the actual identity of the entity linked to an address, but the requestor has proof that the Identity had been verified by a reliable source or service. As a variation, in some embodiments, a user may be able to select and/or view the identity verification service being used to generate the verification status.

Further, the disclosed scoring system can provide a degree of privacy beyond what is currently available both on and off blockchain. This is because it removes the need to share personal/private information with 3rd parties that currently require that private information to facilitate a transaction or interaction.

As another example, consider the task of online shopping. Conventional eCommerce systems require a person to share their identity information, their address, and information on a financial/payment vehicle. This is a large amount of identifying information that is being transferred to a retailer. Employing the proposed scoring method as a zero-knowledge proof of identity (ZKPI), the retailer would only receive a blockchain address to conduct the transaction. All identifying information, address etc. could be held in a secure data repository not controlled by or visible to the retailer, and would only be referenced to facilitate automated fulfilment of a transaction.

In one embodiment, the disclosure is directed to a method for controlling or otherwise regulating transactions that are executed using a blockchain by using data contained within a blockchain to generate a metric that represents the behavior of a party. In one embodiment, the party is identified by a hash or hashes, which represent an address of a party or parties. In one example use case, the metric or score can be used to quickly and objectively assess a hash/address to determine whether it meets criteria to allow or disallow it to interact with a smart contract or engage in a transaction. In some examples, the score or metric may be used to determine the terms of a transaction by causing a specific clause or condition to be satisfied.

In another use case, the score may be used to segment multiple addresses into address segments or groups, thus creating blockchain-address based demographic data. This may be used to identify the type of address demographic that participates in a particular blockchain activity. For example, one could determine addresses that interact actively in the meme token space and do not have any activity connecting them with stable coin trading. This information may be used to tailor services or products to target specific behavioral demographics. A new meme token looking to conduct a pre-sale may use a particular score metric, and based on that metric, either allow or prevent an address from participating in the pre-sale. In this way an actor's previous transaction history and behavior regarding transactions may be used to determine whether that actor is eligible to participate in a new transaction or agreement.

For services where a blockchain address is used as a means of gating, login or entry validation, the disclosed score associated with the blockchain address can be used to serve targeted content, by referencing a desired (or calculated) score as a criterion to display or not display specific content. As an extension of this concept, the score can be used as a criterion to cause the display (or not) of data based on logic that references a threshold score. In one embodiment, a score reflecting the KYC (know your customer) status of an address may be used to permit or deny login or registration to a service. Additionally, interaction with a smart contract (as well as execution of a clause or satisfaction of a condition) can be gated based on a minimum/maximum score criteria. In another embodiment, a score reflecting a particular crypto-currency trading pattern may cause the presentation of targeted advertisements. In these examples, the generated metric and associated logic may serve as a selective and regulatory mechanism for proposed blockchain interactions. This enables a level or layer of control not possible with current uses of blockchain and allows the introduction of other factors into determining whether to allow execution of a transaction or to place a condition upon it being executed.

Examples of such factors may include but are not limited to the age of an address, the frequency of state changes associated with an address, the value of assets (e.g., tokens/coins/NFTs) associated with an address, the address' relationships with other addresses, the types of state changes associated with an address (e.g., smart contract creation, etc.), off-chain factors such as know your customer (KYC) status and other identity related states, the ownership of assets, or other factor(s) that can be used as a condition and that may be used as data points and included in the generation of a metric. Note that if sufficient training data is available (and labeling or annotating that data is feasible), then a trained machine learning model may be used to set or alter a threshold value that is part of the logic used to allow or disallow a transaction based on a set of features and whether the presence or absence of those features indicates a reliable party to a transaction (and hence a transaction that should be allowed, or at least not denied at that stage of the decision process used to evaluate the party).

In one embodiment, the disclosed method may include the following steps, stages, functions, processes, or operations:
A party interested in qualifying a blockchain address (such as may be represented by a hash) or a group of addresses by determining the associated entity's value, suitability, utility, reliability, or qualification to participate in a transaction, etc. declares (i.e., identifies) an address or a group of addresses to be scored;
   This declaration or request may be presented to a remote server using an application, navigating to a website, using a browser plug-in, or other suitable technique accessible to or installed on a client device;
   In one embodiment, an application installed on a client device may be used to enter the address, select a desired scoring method, and generate a message to a remote server to execute the desired method;
      In one embodiment, the application may receive data from the remote server and use that in the client device to calculate or determine the score or metric, followed by alerting the user of the device to the outcome and requesting further instructions;
The requesting party may also specify the type of score or scoring methodology that it desires to receive. The type of score may include identification of a specific scoring algorithm or methodology, and/or the data types or categories to be used to generate the score;
   The scoring methodology selected may be determined by a specified use case, such as the purchase of a specific type of token;
   In some embodiments, the scoring methodology determines the requested score based on the selection of state changes of data recorded on a blockchain, as well as application of data manipulations, equations, or scoring algorithms (in some embodiments, on-chain state changes may be combined with off-chain data);
   The selection of state changes that are used to derive a given score may be determined by the requesting party, by a 3^{rd} party such as a scoring service provider, by a machine learning system, or by another party that is responsible for determining the data used to generate a score;
The blockchain address and the type of score to be derived are submitted to a system or platform that executes the described method to generate the metric;
   This submission can be done using manual inputs, API's, an application, a plug-in, or other data submission methods such as a web interface;
      Services or functions provided by an embodiment of the disclosed system or platform may be implemented in the form of a multi-tenant or Software-as-a-Service (SaaS) platform;
         In such an implementation, each account may correspond to a user, to a group of users, to an organization, to a type of scoring methodology, to a type of transaction, or to other suitable group, category, or entity as examples;
   The submission method, element, or component may permit the querying party to select one or more precompiled scoring methods and options that most closely fit their use case and/or purpose for requesting the score;
The system queries a data source to obtain the selected state changes (transactions) that the provided address has been associated with. This data source may be a blockchain, an index of blockchain data, or other query-able record of blockchain state changes;
   In some embodiments, if the data source is a blockchain, then this querying may be accomplished using a blockchain explorer function or application;
The data obtained for the address is then processed by a suitable set of data manipulations (which may include one or more of equations, formulas, relationships, transforms, mappings, rule-sets, or trained models, as examples) to generate a specific representative result for those transactions;
In some embodiments, the result or results are then mapped onto a scoring table/grid and assigned a value;
   The mapping process may operate to transpose raw inbound data into algorithmically usable (that is, standardized) values. This transposition/mapping assists in maintaining consistency of the input variables used in the algorithm or other score generating process;
      For example, raw input results may be mapped to individual 100-point scales associated with components of a score. Machine learning (ML) models can be used in this transposition process where new “raw” data results fitting a certain pattern are transposed to usable values based on previous (learned) transpositions. The transposition data processing flow is used to derive a consistent initial component value for a contribution to a scoring approach;
The transposed scores are algorithmically processed and presented individually for each component, and (optionally) combined to create scoring subcategories (groups), or combined to create a master or overall score;
   a As non-limiting examples, algorithmic processing that is part of a scoring methodology can take the form of a sum, difference, product, and quotient, exponentiation, logarithm, as well as averaging forms such as mean, median, mode, midrange, and range;
   As a non-limiting example, summation of each component score may be used to create a master score: Score=a₁+a₂+a₃ . . . aₙ, or the processing may be more elaborate and use the mean score of components to generate a group score which would then, together with other group scores, be summed to create a master score:

Score=[(a₁+a₂+a₃ . . . aₙ)/n]+[(b₁+b₂+b₃ . . . bₙ)/n]+[(c₁+c₂+c₃ . . . cₙ)/n] . . . [(z₁+z₂+z₃ . . . zₙ)/n];
The generated score(s) may he used with associated logic, rules, conditions, or constraints to control or regulate the execution of a clause in a smart contract or other use case in which the score is considered as part of the executable logic when making a decision (examples of which are described in the following);
   For example, the logic may prevent execution of a clause or occurrence of an event in a smart contract unless the generated score satisfies a condition, such as being greater than a specified value or within a range of values;
   As another example, the logic may cause specific content (such as an advertisement, offer, promotional material, etc.) to be presented to an address if the generated score falls within a certain range or above a threshold value;
   As another example, the logic may determine which clause of several in a smart contract is executed based on the score associated with the address;
      This might be used to vary the amount of interest or deposit required for a party to the contract based on the score;
      This might determine the amount of earnest money required to be placed into escrow;
      This might be used to determine the amount of an asset (tokens, coins, etc.) allocated to a party;
      This may serve as a gating process to determine the level of access to another linked smart contract;
      This might be used to determine access to a resource such as a particular web page or certain digital document; or
      This might be used to determine the leverage available to a trader;
As another example the generated scores) can be used as a guiding factor in an external actor's decision-making process regarding the address for which the score is generated;
Individual address scores can be aggregated into a representative data set and averaged (mean, mode, median) to create a reflective set score for purposes of comparison with other sets or with an individual score, as an examples.

In one embodiment, the disclosure is directed to a system for controlling or otherwise regulating transactions that are executed using a blockchain by using data contained within a blockchain to generate a metric that represents the behavior of a party. The system may include a set of computer-executable instructions and an electronic processor or co-processors. When executed by the processor or co-processors, the instructions cause the processor or co- processors (or a device of which they are part) to perform a set of operations that implement an embodiment of the disclosed method or methods.

In one embodiment, the disclosure is directed to a set of computer-executable instructions, wherein when the set of instructions are executed by an electronic processor or co- processors, the processor or co-processors (or a device of which they are part) perform a set of operations that implement an embodiment of the disclosed method or methods.

In some embodiments, the systems and methods described herein may provide scoring services through a SaaS or multi-tenant platform. The platform provides access to multiple entities, each with a separate account and associated data storage. Each account may correspond to a source of a scoring request, a set of sources, a specific use case, a specific type or method of generating a score, or an organization, for example. Each account may access one or more services, a set of which are instantiated in their account, and which implement one or more of the methods or functions described herein.

In one embodiment, a score or metric can be obtained by permissionless or permissioned access to a scoring portal where a user inputs an address. Input can be made by manually populating an address field, by permitting the establishment of a link to an address repository such as a wallet, by programmatically pulling addresses to be scored such as a chain scrape or data repository retrieval of a set of addresses, or other suitable method. Inputted address scores can be displayed via public or intranet web pages and applications or by access to compilations of scores such as databases or files. A factor in sharing the ability to generate a score is the provision of an address to an interface that communicates with the scoring algorithm. In general, if an address is presented, a score can be generated regardless of the input/output interface.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1(a) is a flowchart or flow diagram illustrating an overview of a method, process, operation, or function for receiving a request for a blockchain score or metric, generating the requested score, and providing the score to the requester, in accordance with some embodiments;

FIG. 1(b) is a more detailed flowchart or flow diagram illustrating a method, process, operation, or function for receiving a request for a blockchain score or metric, generating the requested score, and providing the score to the requester, in accordance with some embodiments;

FIG. 1(c) is a flowchart or flow diagram illustrating further details of the processing of a request to generate a blockchain score, in accordance with some embodiments;

FIG. 1(d) is a flowchart or flow diagram illustrating details of the process of generating a blockchain score, in accordance with some embodiments;

FIG. 1(e) is a diagram illustrating a method, process, operation, or function for accessing a blockchain and obtaining data corresponding to an address for use in generating a blockchain score, in accordance with some embodiments;

FIG. 2 is a diagram illustrating elements or components that may be present in a computer device, server, or system configured to implement a method, process, function, or operation in accordance with some embodiments of the invention;

FIG. 3 is a diagram illustrating a process flow for generating a blockchain score for an entity engaged in purchasing tokens, in accordance with some embodiments;

FIG. 4 is a diagram illustrating a process flow for generating data regarding the verification of an entity's address and using that information as part of a blockchain score, in accordance with some embodiments;

FIG. 5 is a diagram illustrating an example of how the disclosed score may be used to interact with a smart contract, in some embodiments;

FIG. 6 is a diagram illustrating a process flow for generating a blockchain score for a situation in which a Negative ISCp Table is used, in accordance with some embodiments;

FIG. 7 is a diagram illustrating a process flow for generating a blockchain score for a situation in which an undeclared weight is used, in accordance with some embodiments; and

FIG. 8 is a diagram illustrating a process flow for generating a blockchain score for a situation in which a triggering event may override a step or stage of the process flow used in a scoring algorithm, in accordance with some embodiments.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

Embodiments of the systems, apparatuses, and methods described herein are directed to evaluating, controlling, or otherwise regulating transactions that are executed using a blockchain by using data contained within a blockchain to generate a metric that represents the behavior of a party. Based on the generated metric or score the party may be presented content, have their participation in a transaction permitted or disallowed, condition their participation in a transaction, select the terms of a contract, or execute a specific process, as examples.

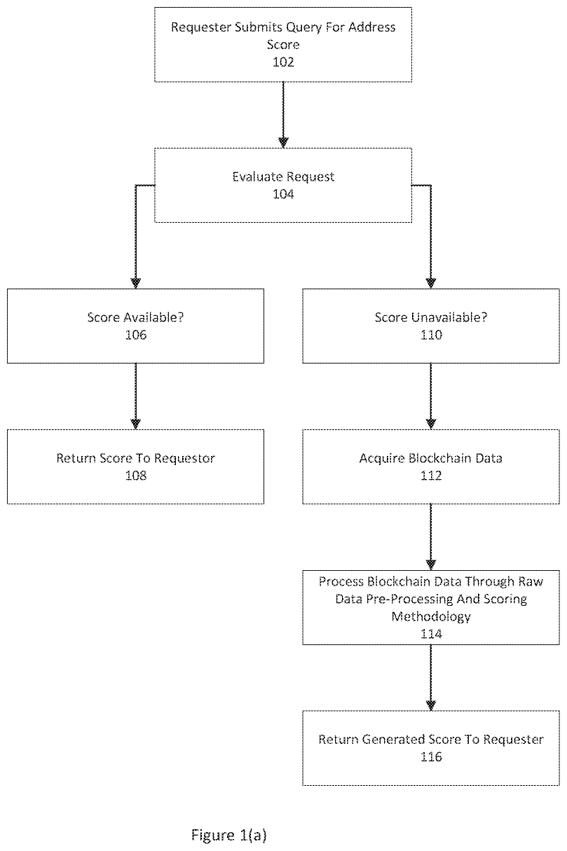

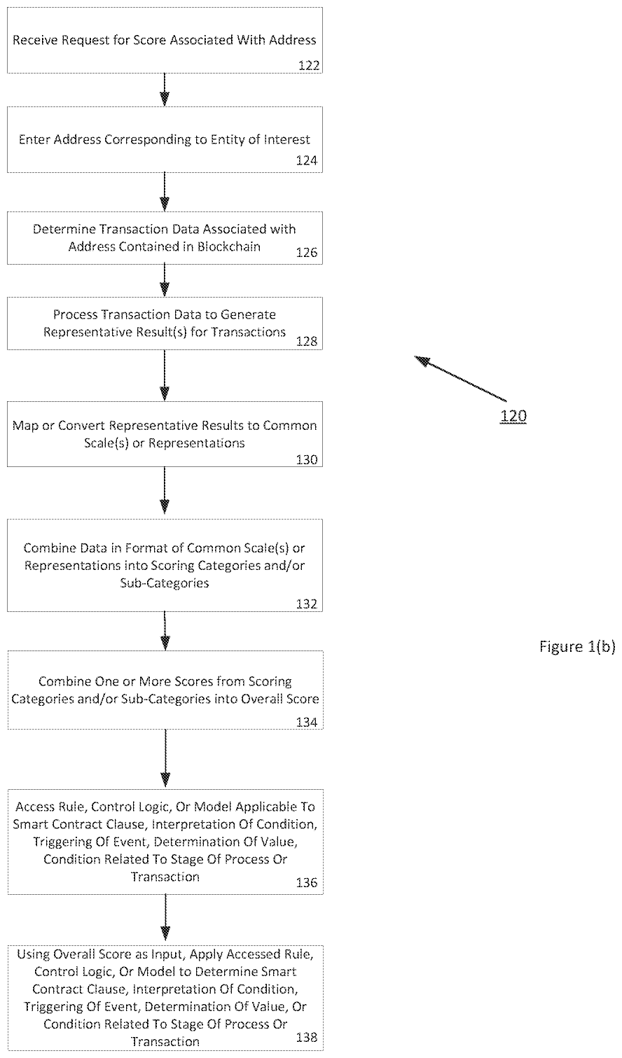

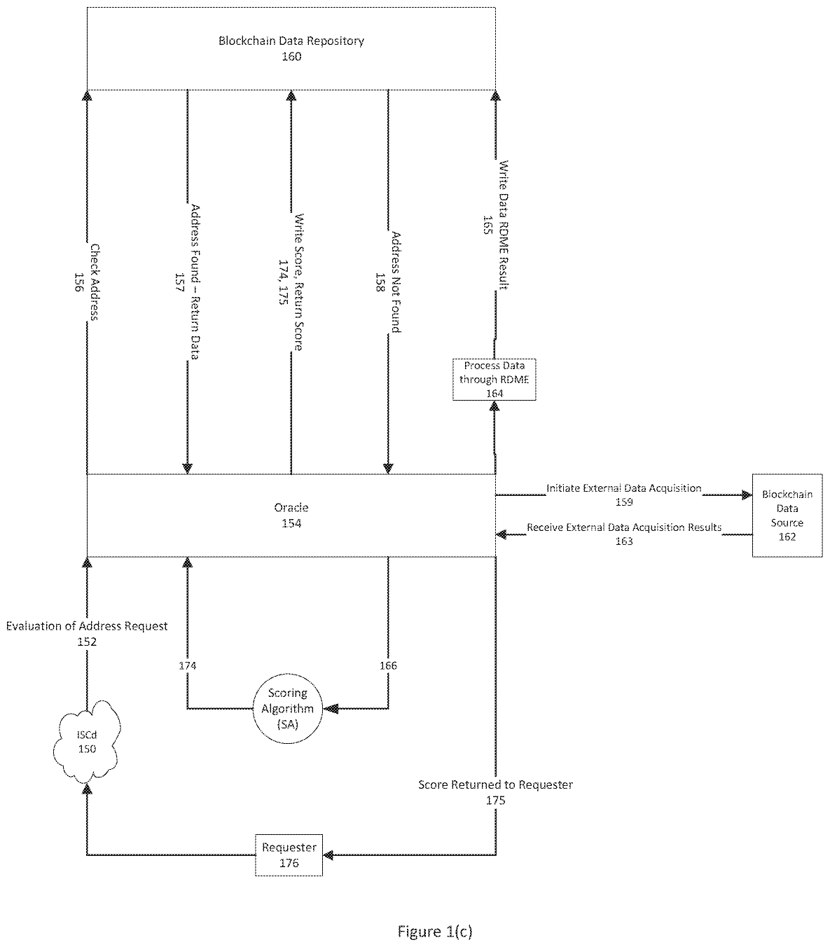

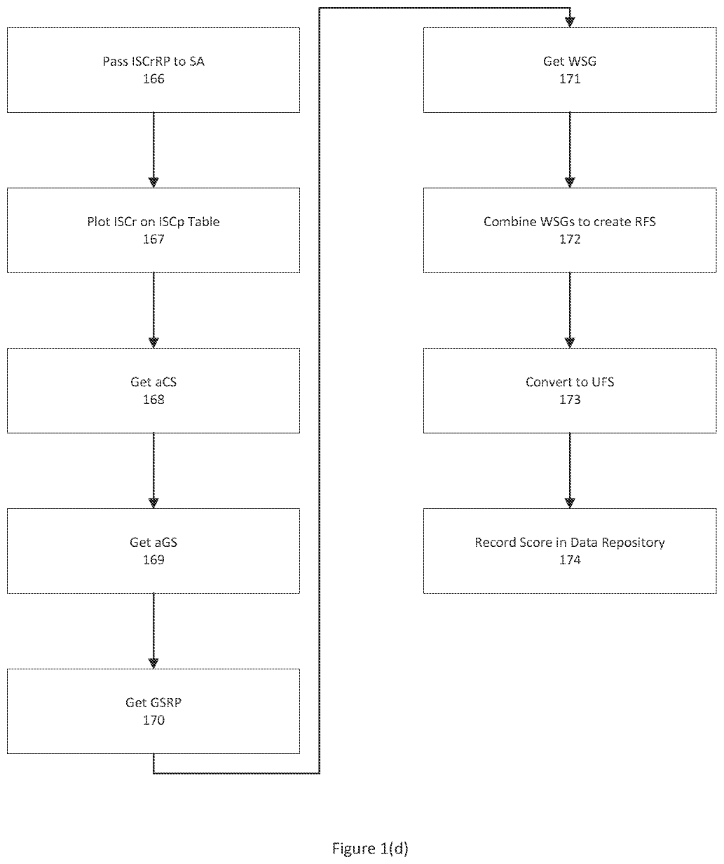

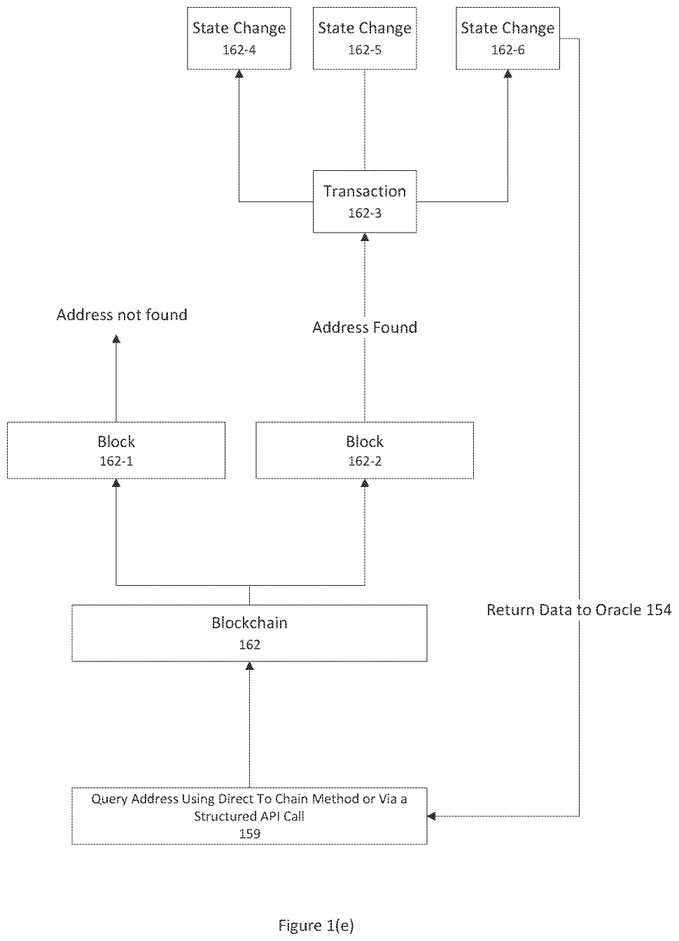

FIG. 1(a) is a flowchart or flow diagram illustrating an overview of a method, process, operation, or function for receiving a request for a blockchain score or metric, generating the requested score, and providing the score to the requester, in accordance with some embodiments. As shown in the figure, in one embodiment, a score request and retrieval process flow may comprise:
A requester submits a query for an address score, that is, for the generation of a score associated with the specified address (as suggested by step or stage 102);
In response to receiving the query or request, the process then determines if a score associated with that address is available (as suggested by step or stage 104);
   In one embodiment, this may include determining if a score based on a specific scoring methodology is available if the request or query submitted in 102 specified one;
If the logic determines that a score is available (as suggested by step or stage 106, and as may result from a lookup table or database query), then
The score is accessed and provided to the requester (as suggested by step or stage 108);
   In one embodiment, the score may be accompanied by a description of the scoring method used and information regarding the source of the data used, alternate scoring methods available, or other features of the process;
If the logic determines that a score is not available (as suggested by step or stage 110 and as may result from a lookup table or database query), then
The process acquires the blockchain stored data needed to determine the score using the selected or default scoring methodology (as suggested by step or stage 112);
The acquired data is then processed, which may include raw data pre-processing, such as data conversions, data transformations, or data mappings, as examples, and then the selected or default scoring methodology is applied to the data (as suggested by step or stage 114);
The generated score is then provided to the requester (as suggested by step or stage 116).

FIG. 1(b) is a more detailed flowchart or flow diagram illustrating a method, process, operation, or function 120 for receiving a request for a blockchain score or metric, generating the requested score, and providing the score to the requester, in accordance with some embodiments. As shown in the figure, a request is received for a score associated with a blockchain address (as suggested by step or stage 122). The blockchain address (such as a hash) corresponding to an entity of interest is entered into a system that executes the described method to generate the metric (as suggested by step or stage 124). A data source such as a blockchain is then queried for transactions conducted by the address (as suggested by step or stage 126). This may be accomplished using a blockchain explorer application, for example.

One such example of a blockchain explorer application uses declared important state changes as inputs. These important state changes are transactions that are the constituent parts of a desired type of scoring methodology. In one example implementation of a blockchain explorer, a selection of transaction types is combined to create a query package (termed an Important State Change Declaration) that is passed to the blockchain explorer. The blockchain explorer parses this Important State Change Declaration and via queries to a blockchain extracts transactions that meet the declared query specifications.

The transaction data obtained for the address is processed by a specific set of data manipulations (which may include equations, formulas, transformations, mappings, use as inputs to a trained model, as examples) to generate a specific representative result for those transactions (as suggested by step or stage 128). These data manipulation equations may distill raw data input into representative and/or functional results. In one sense, the data manipulations tally state changes, transactions, and time intervals. For example, a sum operation may be used to tally the number of distinct tokens associated with an address (Token A+Token B+ . . . =Total Tokens). Another example is use of averaging formulas: where the average number of transactions per a specific time interval is determined (i.e., the number of transactions/number of Weeks=number of transactions per week). Another example is a profit and loss calculation (Proceeds of asset sale−cost of acquisition of asset=Profit or Loss on Asset).

The obtained result(s) are then mapped or converted to a common scale or standardized representation (as suggested by step or stage 130). In one embodiment, the generated results are mapped onto a scoring table/grid and assigned a value. The mapping or conversion is part of a process flow that operates to transpose raw inbound data into algorithmically usable (standardized) values. For example, raw input data that has been passed through the initial data manipulation equations where a sum or average has been obtained may be mapped on individual 100-point scales associated with components of a score. Machine learning can be used in this transposition process where new raw data fitting a certain pattern is transposed to usable values based on previous (learned) transpositions. In one embodiment, the transposition data processing flow is used to derive a consistent initial component value.

The transposed or converted values may then be assigned individually to a score component, combined to create scoring subcategories (groups), or combined to create a master score (as suggested by step or stage 132). Categories are collections of score components that represent a common theme. For example, the category or group identified as “Velocity”, would be a group of components that represent the number of actions associated to an address within a specified period: the number of new tokens added per week, the number of buy and sell transactions, or the amount of time a token is held before the first sell transactions is made, as non-limiting examples. Another example of a category or group could be “Risk”. This grouping would have constituents that represent the subjective probability of Profit & Loss: the number of low cap tokens held, the P&L on tokens held in the last 6 months, or KYC status, for example.

The category, subcategory, or group scores may then be combined to generate an overall or master score (as suggested by step or stage 134). Categories, subcategories, groups, or whatever term is chosen to refer to these constituents of a score are building blocks that may be used to generate a master score. The number of these building blocks, their relationships to each other (such as relative weights), or their positions within hierarchies is typically governed by the complexity that is required to generate a desired master score.

Next, a set of rules, control logic, models, if-then statements, or similar type of decision tool are accessed and used to determine the impact of the category, subcategory, or master score(s) (as suggested by step or stage 136). The rules, control logic, models, or similar type of decision tool may be associated with a specific party to an economic transaction, an entity in a smart contract, an entity in another type of transaction or exchange that is conditioned on specific events or values, etc.

The accessed rules, control logic, models, if-then statements, or similar type of decision tool are applied using the generated score or scores as inputs to determine a relevant condition, event, or quantity for a clause in a smart contract, an aspect of a transaction, or whether to trigger a condition or event, as examples (as suggested by step or stage 138). The logic may prevent execution of a clause or occurrence of an event in a smart contract unless the generated score satisfies a condition, such as being greater than a specified value, the logic may cause specific content to be presented to an address if the generated score falls within a certain range, or the logic may determine which clause of several in a smart contract is to be executed based on the score associated with the address, as non-limiting examples.

In describing one or more example embodiments of the disclosed system, apparatuses, and methods, the following terms and abbreviations are used:
Important State Change—ISC
Important State Change Declaration—ISCd
Important State Change Modifier—ISCm
Important State Change Result—ISCr
Important State Change Points—ISCp
Important State Change Points Representative Percentile—ISCpRP
Important State Change Results Return Package—ISCrRP
Declared Family Weight—DFW
Declared Group Weight —GDW
Declared Component Weight—DCW
Raw Data Manipulation Equations—RDME
Group Score Representative Percentile—GSRP
Weighed Score of Group—WSG
Scoring Algorithm—SA
Maximum Important State Change Points—mISCp
Actual Component Score=aCS
Actual Group Score=aGS
Family Point—Fp
Raw Family Score—RFS
Usable Family Score—UFS
Oracle—O
DSFM—Desired Scoring Format Modifier
   Note that for most purposes the technical term “State Change” is interchangeable with the term(s) “blockchain carried data”.

A preparatory step in generating a score is to access or determine and declare the pre-requisites and constants. A scoring algorithm or methodology may reference constants as part of the process of deriving a score. The constants can be housed as flat lists, tables, data repository entries, in code and/or referenced arrays, or in payload format files such as the json format¹, as examples. As examples, the following pre-requisites and constants are representative but not required or exhaustive. ¹ JSON is an open standard file format and data interchange format that uses human-readable text to store and transmit data objects consisting of attribute-value pairs and arrays (or other serializable values).

### Hierarchies

Hierarchies are used to organize data based on the amount of processing done on that data. For example, data that has gone through an initial data manipulation equation such as a sum of transactions, would be on the First Level of a hierarchy. Derivative data resulting from the manipulation of first level data, such as the averaging of first level data results, would be considered Second Level data in the hierarchy, and so on through multiple hierarchies. One can distill this concept as follows:
a. First level is a component. A component is an individual Important Data type;
b. Second level is a group. A group is a collection of Important Data types;
c. Third level is a family. A family is a collection of groups; and
d. Subsequent levels can be created using this type of hierarchical approach.

The Table below is representative of an example of such hierarchies:

| Subsequent Levels | Group of Families . . . i.e., Community |
|---|---|
| Third Level | Family |
| Second Level | Group |
| First Level | Component |

### Data Weight

The weight of an item of data is the importance of the data within a set of data at a given hierarchy level. If there is a single data point, it by default holds the maximum weight of its singular set. Below is an example of declared data weights, for purposes of illustration only. Weight values are set to reflect end use of the score and determine the relative importance of each data point to the overall end score. Weight(s) can be declared in the ISCd or be contained in an external reference repository. The weights can be set by users manually or programmatically using values provided by a trained Machine Learning model.

| | Family | | | |
|---|---|---|---|---|
| Declared | 35 | | | |
| Family Weight | | | | |
| (DFW) | | | | |
| | Group Alpha | | | Group Beta |
| Declared | 10 | | | 25 |
| Group Weight | | | | |
| (GDW) | | | | |
| | Component | Component | Component | Component |
| | X | Y | Z | AA |
| Declared | 2 | 3 | 5 | 25 |
| Component | | | | |
| Weight (DCW) | | | | |

### Machine Learning Models

Using machine learning, one can facilitate faster and dynamically accurate creation of relevant constants. For example, these constants may comprise one or more of component, group, and family weights. If the requestor of a score is an address associated with a crypto trading platform, then frequency of trades is desirable and should carry higher weight in the score. Therefore, one would implement a DCW (declared component weight) of the number of trades component to equal 70% of the GDW (declared group weight). The system would train the scoring algorithm using a data set comprised of verified official crypto trading platform addresses. The system/algorithm would look at the characteristic state changes that are common to addresses of crypto trading platforms. This could start with broad characteristics such as a high number of send state changes, and gradually be narrowed down to more subtle aspects, such as sends going to external actor addresses as opposed to smart contract addresses.

When the Oracle (as described herein, the controller or mediator of requests for a score or metric) receives a scoring request, it runs the requesting address against the machine learning derived category of addresses. If the address is one in the crypto trading platform group, then the DCW given to the number of trades would be increased to reflect that within the overall score.

### Scoring Tables

Scoring tables are a mechanism or process for transposing results. They take a result and assign it a representative value. For example, an ISCp Table is used for the transposition of ISC data results to one or more predetermined representative points or values. An Fp Table is used for the transposition of a master score point result into a string.

It is not necessary for Scoring Tables to maintain consistency within their hierarchies, however for ease of use it may be advisable to implement this feature for ISCp Tables. This means that, for ease of use, there should be a consistent point scale used by components, groups, and families within hierarchies. For example: 0-100 for components, 0-10 for groups, 0-1000 for families. The maximum value of a point scale is termed Maximum Important State Change Points (mISCp) herein. For example, if the scale for ISCp is 0-100, then the mISCp is 100, if it is 0-10, then the mISCp is 10. Below are examples of such Tables:

Important State Change Point (ISCp) Table

| | ISCp | ISCr |
|---|---|---|
| mISCp | 100 | 0 |
| | 90 | 1 |
| | 80 | 2 |
| | . . . | . . . |
| | 0 | 10 |

Family Point (Fp) Table

| Mp | Rating |
|---|---|
| 750-1000 | Excellent |
| 500-749 | Good |
| 250-499 | Fair |
| 0-249 | Poor |

### Data Sources

To facilitate the delivery of ISCr to the Scoring Algorithm (SA), the disclosed method sources required ISC instances. In one embodiment, these sources are:
Blockchains; and/or
Indexes of Blockchain state changes (e.g., Data Repositories).

ISC data is derived by querying a blockchain directly via blockchain clients and their data query protocols such as JSON-RPC API, JavaScript, python etc., or by querying a data repository such as an index of blockchain data using a dedicated query protocol;
This is similar to the functionality of a blockchain explorer which scans transactions on a chain, although as described herein, the implementation and features may differ.

A data source can also be an intermediate temporary storage state such as cache, RAM, or temp files, for example. In one embodiment, temporary storage can be used to determine/modify scores in real-time. Similarly, processed and generated scores can be stored both off and on-chain depending on resource availability, use case, and security considerations.

### Oracle (O)

In the context of the disclosure, the Oracle (O) functions or operates as a controller or central processing unit that decides what is to be done with requests for data, or what is to be done with the results of the requests, for example. Instructions for O can be hard coded or be called from external references. Example logic implemented or executed by Oracle is presented below.

### Raw Data Manipulating Equations (RIME)

Equations or formulas may be used to distill raw data input into representative and functional values that are useable by a scoring algorithm. Raw data manipulating equations (or functions or operations) are algorithmic processes such as sum, difference, product, and quotient, as well as averaging forms such as mean, median, mode, midrange, and range. This list of processing functions or operations is not exclusive but illustrates several common examples. For example, one could use summation of each ISC to create an ISCr: ISCr=ISC₁+ISC₂+ISC₃ . . . ISCₙ or the process can be more elaborate and use the mean result of ISC's to generate in ISCr: ISCr=(a₁+a₂+a₃ . . . aₙ)/n.

### Scoring Algorithm (SA)

The scoring algorithm (or formula, equation, or model, as examples) is a set of mathematical and/or logical equations that generates a score representative of an input. Results obtained from data sources are passed through the Scoring Algorithm to obtain a scoring value or result.

### ISCr Requesting Entity

There are two types of requesting entities that may initiate contact with the Oracle for the purpose of obtaining a score. These entities are smart contracts and non-smart contract requesters. An example of a non-smart contract requester is an externally owned address or an-off chain entity, such as a financial institution initiating a score request via an API.

### Target

Every request for a score that is processed by the Oracle needs to be in relation to a declared blockchain address, that is a target.

In some embodiments, the general form of a score or metric is a numerical representation of selected data obtained from blockchain state changes. The state changes are evaluated using an algorithm (or formula, model, or equation, for example) and the result of the evaluation is displayed as a numerical value on a pre-determined scale. The numerical value is then interpreted by logic (such as a rule set or model) to make a decision regarding a transaction. The scoring algorithm can be built into blockchains via a Virtual Machine type of integration (e.g., the Ethereum Virtual Machine), as functional reference calls to a centralized or distributed scoring algorithm, or built into smart contract code itself, as examples.

The scoring method, algorithm, or ruleset may be determined or selected by the party requesting the score, a scoring provider, or a scoring algorithm repository, as examples. The scoring method is flexible in this respect and is typically an iteration of calculating user defined/specified state changes, reporting/tallying/averaging results, and measuring intervals between state changes.

In one embodiment, the disclosed score or metric may be generated by the following set of steps or stages:

### Step 1: Create, Declare or Retrieve ISCd (As Suggested by Step, Stage, Process or Component 150 of FIG. 1(c))

Blockchain transaction data is a record of distinct, time stamped state changes associated with a blockchain address. This transaction data is stored as constituents of data blocks linked together to form a blockchain. Because of the immutability of the blockchain, state changes recorded on the blockchain are distinct and individually identifiable. State changes are grouped together with like state changes, creating distinct types of state changes:
   These distinct types of state changes have a universally adopted nomenclature. For example, the address initiating a value state change is called a SENDER, and the address having its value state changed is termed the RECIPIENT. A state change that is the result of the association of an asset to an address that is paired with a dissociation of an asset can be termed a BUY and conversely, the state change that is the result of the dissociation of an asset (or portion thereof) from an address that is paired with the association of an asset can be termed a SELL.

To generate an address score, an embodiment performs specific mathematical calculations using a selection of the applicable state changes. Depending on the end use of the score, certain state changes may be more or less important in the generation of the score. Based on this relevancy, state changes are selected to be used (or not) as initial inputs for the scoring method.

Important State Changes (ISCs) that are included in the score generating method can be assigned individual importance (weight) within that scoring instance.

Important State Changes (ISCs) can be put together to create a data package called an Important State Change Declaration (ISCd). These declarations (ISCd) are an efficient method of delivering ISCs to the disclosed scoring system. Below are non-limiting examples of data and instruction payloads that an ISCd may carry/transport:
Instructions on how to process the raw data results of queries about an address' ISC results;
Interval or time instances to be used in the processing of raw data results;
Identifying the blockchain(s) from which data is to be used or not used;
Scoring thresholds to be used;
Important State Changes to be used;
Identifying the blocks or block ranges that are to be used or not used; or
Identifying the desired variant of a scoring algorithm to use in the generation of a score.
   It should be noted that a distinct ISCd can be synonymous with a score variant as it may embody the distinguishing characteristics that make up a particular variation of a score. The ISCd can be a master data payload, delivered (for example) via a json file; such a file may contain the necessary constants involved in the generation of a score (variant).

A list of pre-compiled ISCd can be made available to requesters and smart contracts. It is beneficial to have a set of pre-compiled ISCd as they reflect the type of state changes and instructions that are passed to the scoring system based on common use cases of the score or scoring approach. The constitution of such pre-compiled ISCds would typically be determined by the end use case of the score, and one can use industry specific generalizations to create these pre-compilations. The pre-compiled declarations (ISCd) can be refined and augmented based on identified or recognized patterns of use based on manual analysis, statistical analysis, or with machine learning models, as examples.

For example, machine learning can be used to study frequencies of ISCd's used per industry, thus enabling machine generated ISCd's. For example, one could use a training data set for the Finance industry comprised of ISCd's where the ISCs—Age of Address, Type of Asset, and Profit & Loss (P&L) are relevant. If a requester is a smart contract and is looking to assign a lending rate to an address based on a score, then the system detects the logic within the requesting smart contract, for example: “If returned score=“a”, then give rate x; if returned score=“b” then give rate y”. In such an example, an ISCd comprised of Age of Address, Type of Asset, and P&L is used or generated.

Non-limiting examples of industry-specific applications and uses of the disclosed system and methods are provided in the following.

### An ISCd Example for a Token Sale

As an example use case and implementation, assume a smart contract which a party would like to limit access to, such as for participation in a sale of a token. The party can accomplish this access control by implementing a score-based access gating process. A score-based process may check if an address requesting access meets or does not meet a specified score or range of scores. If the score or range is satisfied, then access would be permitted; if the score or range is not satisfied, then access would be denied. In one example of this type of decision process, the following steps or stages may be performed:
a) The party decides that it will use a score providing service to obtain a score for its score-based access gating. The score provider has various scoring algorithms or methods available for users, with each using varying inputs and algorithms to determine a score;
b) The party decides to use a specific scoring variant, as it fits the motivation and use case of the party;
c) The scoring variant selected is generated by using a specific Important State Change Declaration (ISCd) and running the data generated by the ISCd through a specific version or iteration of a Scoring Algorithm;
d) The party declares the use of score-based access gating in a smart contract and declares the score result that an address must receive to be permitted access to the smart contract (and/or to cause the execution of a specific term, condition, or clause in the contract). For example, the party declares that the score of 500 is the minimum needed to be permitted access to the smart contract;
e) Each access request from an address received by the smart contract is then checked against the declared scoring criteria by sending an address score request to the score provider;
f) The score provider provides the address to the scoring system and either retrieves an already generated score and returns it to the smart contract, or if a score is not available, then the scoring system generates a score and sends the result to the requesting smart contract;
g) In one embodiment, the score variant used is generated by a scoring method that uses the number of weekly buy transactions of an address and the total value of those transactions. These buy transactions and their values are state change types that are recorded on the blockchain. These state change types (alone or in combination with one another) are used to generate a score reflecting the traits of the entity associated with the address;
h) In this example, the following Important State Change (ISC) types may be part of the associated ISCd. The scoring method can append this declaration of the state changes that are important in the context of a specific use case, with modifications based on what is included as part of a state change record:
   The address(s) to be looked up;
   The number of times an address was a buyer of coins/tokens;
   The sum of coins/tokens associated with each instance in which an address was a buyer;
   A time interval to use in the counting of buy instances and their associated values;
   The group each ISC is assigned to;
   The weight of each ISC within the group it's assigned to;
   A specific version of the scoring algorithm to use; and
   The score threshold to be met in the decision logic.

In this example, the Important State Changes Declaration (ISCd) may be expressed in pseudo code as follows:

```
1. ISCd Gamma = {
2. Address = XYZ₁, XYZ₂, ... XYZₙ
3. For each Address:
  a. ISC1 = Buy Instances
  b. Count ISC1
  c. Average ISC1 count using a 7-day interval
  d. ISC1 in Group 1
  e. ISC2 = Value of ISC1 Buy Instances
  f. Average ISC2 value using a 7-day interval
  g. ISC2 in Group 2
  h. Group 1 weight = 20
  i. Group 2 weight = 10
  j. ISC1, ISC2 modifier = use blocks ≥1000 & ≤2000
  k. Use scoring algorithm Gama
  l. Score threshold =>500
4. }
```

### An ISCd Example for the Finance Industry

In this example use case, the following information may be used in determining a score and then making a decision based on the generated score:
Age of the Address—the older the address the larger the data sample size available to derive an inference about the address;
Type of Assets—this information assists in determining risk. Holdings skewed towards low cap, meme/no use case tokens, may indicate a higher risk of a party defaulting on a loan;
Profit and Loss (P&L)—Profit and loss on holdings. Can be used as a moderating indicator to the type of asset ISC;
   If the address is turning out consistent profit on higher risk assets, then Type of Asset ISC may not be as important and may be given less weight;
   If the case is the opposite and the address is carrying a net loss on its transactions, then it may increase the importance or weighting of Type of Assets;
   This is a generalization, as additional factors would typically play into a lender's decision to interact with a party seeking a loan, but it is indicative of the types of ISCs that could be part of a decision-making process and be constituents of an ISCd.

Given the above as an example, the corresponding ISCd may take the following form:

| 1. | ISCd = { | |
|---|---|---|
| 2. | Address = XYZ₁, XYZ₂, ...XYZₙ | |
| 3. | ISC1 = Age of Address | |
| | a. | Address creation date vs current date = Age |
| 4. | ISC2 = Token Holdings | |
| | a. | Token/Coin |
| | | i. Balance |
| 5. | ISC3 = P&L | |
| | a. | Get token price of each ISC2 (converted to USD) of initial |
| | | buy transaction. |
| | | i. Historical price data DEX/CEX; |
| | b. | If there are more buy transactions before a sell, average |
| | | the price between those buys. |
| | | i. Historical price data DEX/CEX |
| | c. | Get token price of subsequent sell transaction. |
| | | i. Historical price data DEX/CEX |
| | d. | Calculate price change between buy price (or aggregate buy |
| | | price) and sell price then convert it into %. |
| | e. | Do this for every buy/sell “event” and then average the |
| | | % between all events. |

| | |
|---|---|
| 6. | ISCm1 = ≥Genesis & ≤ Latest |

}

### An ISCd Example for a Supply Chain Scenario

In this example use case, the following information may be used in determining a score and in decisions based on the generated score:
Age of NFT—Age of NFT indicates the time an asset (asset=NFT) entered the supply chain;
Velocity—Time intervals between recorded state changes allows determining the speed at which an asset is moving through a supply chain. This may be useful if an interval outside of an optimal or expected amount indicates an inefficiency;
Transaction count—This provides a measure of the number of steps an asset goes through from origin to destination. For example, an unexpected number of steps may indicate an inefficiency.

Given the above as an example, the corresponding ISCd may take the following form:

| 1. | ISCd = { | |
|---|---|---|
| 2. | Address = XYZ₁, XYZ₂, ...XYZₙ | |
| 3. | ISC1 = Age of NFT | |
| | a. | Date NFT added to address assigned to represent first step in |
| | | supply chain vs. current date = Age |
| 4. | ISC2 = Velocity | |
| | a. | Time between state change₁, state change₂, ...state changeₙ |

| | |
|---|---|
| 5. | ISC3 = Transaction Count |
| 6. | ISCm1 = ≥Genesis & ≤ Latest |

}

An example of a .json format based ISCd

```
{
  “nft_group”: {
    “weight”: 4,
    “components”: {
      “owns_nfts”: {
        “mappings”: {
          “type”: “boolean”,
          “mappings”: {
            “True”: 100,
            “False”: 0
          }
        },
        “max_component_score”: 3,
        “value”: True
      },
      “owned_nfts”: {
        “mappings”: {
          “mappings”: {
            “0”: 0,
            “1”: 10,
            “2”: 20,
            “3”: 30,
            “4”: 40,
            “5”: 50,
            “6”: 60,
            “7”: 70,
            “8”: 80,
            “9”: 90,
            “10”: 100
          },
          “type”: “range”,
          “min_value”: 0,
          “max_value”: 10,
          “direction”: “<=”
        },
        “max_component_score”: 2,
        “value”: 3
      },
      “sold_nfts”: {
        “mappings”: {
          “mappings”: {
            “True”: 0,
            “False”: 100
          },
          “type”: “boolean”
        },
        “max_component_score”: 1,
        “value”: True
      },
      “bought_nfts”: {
        “mappings”: {
          “mappings”: {
            “True”: 100,
            “False”: 0
          },
          “type”: “boolean”
        },
        “max_component_score”: 2,
        “value”: True
      }
    }
  }
```

In one embodiment, the disclosed scoring system and methods may be extended to provide a more flexible form of constructing an ISCd, such as one in which an end user creates a customized ISCd for use with the scoring system based on ISCs made available to them. To enable the creation of a customized ISCd, the system may create and provide a list of available ISCs that can be selected via a software interface or selected via API calls.

In one example, an API call can be analogous to currently available direct-to-chain calls, for example, eth_getBalance. In another example, the ISC information may be obtained by a process that retrieves total token holdings per address from pre-compiled data sets found in an index or data repository. In another example, the ISC information may be obtained from a library of processed data points.

In another example, the disclosed system and methods can be extended to create a customized scoring methodology where ISCs, ISCds, Data Sources, Scoring Algorithms, or other terms or factors can be selected by a user facing application, an API, or other user interface.

### Step 2: Communicate ISCd to the Oracle (As Suggested by Step, Stage, Process, or Component 152 of FIG. 1(c))

In one embodiment, an ISCd is sent as a set of instructions to the Oracle or controller (as suggested by element or component 154 in FIG. 1(c)) for processing. The set of instructions may be provided via the Internet using a standard data transfer protocol or internally via an intranet data transfer protocol. As an example, the Pseudo Code for performing this function may take the form:
Send ISCd to O(racle)

### Step 3: Oracle Receives Query and Decides What to do with It (As Suggested by Step, Stage, Process, or Component 154 of FIG. 1(c))

The Oracle functions as a controller that decides what is to be done with requests for data as well as what is to be done with the results of a request. It has its own internal instructions as well as an instruction to read requests in the form of an ISCd.

As an example, the Pseudo Code for executing one or more Raw Data Manipulation Equations (RDME) may take the form:
1. Read ISCd
   2. Run ISCd against Data Repository 160 (as suggested by step, stage, process, or function 156 of FIG. 1(c))
   3. If data found in Data Repository (as suggested by step, stage, process, or function 157 of FIG. 1(c))
      i. Write ISCr1 to ISCrRP
      ii. Write ISCr2 to ISCrRP
      iii. ISC1 Group=ISCr1 Group
      iv. ISC2 Group=ISCr2 Group
      v. Send Return Package to Oracle 154
   4. If data not found or partial data found in Data Repository (as suggested by step, stage, process, or function 158 of FIG. 1(c))
      i. Initiate external data acquisition for missing data, as an example, scrape of blockchain or source data from other record of blockchain state changes, such as indicated by Blockchain Data Source 162 (as suggested by step, stage, process, or function 159 of FIG. 1(c))
      ii. Receive data acquisition results (as suggested by step, stage, process, or function 163 of FIG. 1(c))
      iii. Process data through RDME (as suggested by step, stage, process, or function 164 of FIG. 1(c))
      iv. Write RDME results in Data Repository 160 (as suggested by step, stage, process, or function 165 of FIG. 1(c))
      v. Execute line 3 to write scoring result and send to Oracle 154 (as suggested by step, stage, process, or function 157 of FIG. 1(c))

The Pseudo Code for a non-RDME example may take the form:
1. Read ISCd
2. Run ISCd against Data Repository 160 (as suggested by step, stage, process, or function 156)
3. If data found in Data Repository 160 (as suggested by step, stage, process, or function 157)
   i. For each ISC1+1 to ISCr1
   ii. For each ISC2+1 to ISCr2
   iii. ISC1 Group=ISCr1Group
   iv. ISC2 Group=ISCr2 Group
   v. Write ISCr1 to Return Package (ISCrRP)
   vi. Write ISCr2 to ISCrRP
   vii. Send Return Package to Oracle 154
4. If data not found in Data Repository (as suggested by step, stage, process, or function 158)
   i. Initiate external data acquisition, for example scrape of blockchain or source data from some other record of blockchain state changes, such as indicated by Blockchain Data Source 162 (as suggested by step, stage, process, or function 159)
   ii. Receive data acquisition results (as suggested by step, stage, process, or function 163)
   iii. Write data acquisition results in Data Repository 160 (as suggested by step, stage, process, or function 165)
      1. Function 165 is a write data to Blockchain Data Repository, it is not specific to RDME or Non-RDME;
   iv. Execute line 3 to write scoring result and send to Oracle 154 (as suggested by step, stage, process, or function 157)

A non-RDME example is presented to indicate that there are instances where raw data that is returned from a data acquisition process will not need to pass through further processing by an equation or formula (as examples). Such instances can occur when raw data is Boolean in nature and this result is itself a value that can be readily transposed onto a ISCp Table and used by the scoring algorithm, be used without such transposition, or be returned as a final score directly, bypassing the use of data manipulation equations or scoring algorithms.

### Step 4: The Returned ISCrRP is Passed to the Scoring Algorithm (SA) (As Suggested by Step, Stage, or Component 166);

In one embodiment, the described score or index is generated by the following data processing flow, as illustrated in FIG. 1(d):

### SA Step 1: Pass ISCrRP to Scoring Algorithm (SA) (As Suggested by Step or Stage 166);

ISCrRP is returned to Oracle from a Data Repository. Oracle identifies incoming data as ISCrRP and passes constituent ISCr to scoring algorithm for processing;

### SA Step 2: Plot ISCr on ISCp Table (step or stage 167);

The first function the scoring algorithm executes, is a plot of ISCr onto corresponding pre-assigned and pre-declared ISCp Tables.

Pseudo Code:

If ISCr=x then ISCp=y

### SA Step 3: Get Actual Component Score (aCS) (Step or Stage 168);

Calculate the aCS result that a component received within its Group.

(ISCp*DCW)/mISCp=aCS Example formula

### SA Step 4: Get Actual Group Score (aGS) (Part of Step or Stage 169);

Add all aCS within group to get the aGS,

aCS₁+aCS₂+ . . . aCSₙ=aGS Formula

### SA Step 5: Get Group Score Representative Percentile (GSRP) (Step or Stage 170);

aGS is converted into a percentile of the DGW.

aGS/DGW=GSRP Example formula

### SA Step 6: Get Weighed Score of Group (WSG) (Step or Stage 171);

Each group has an assigned weight in relation to other groups within a family. Similarly, as is the case with components and groups. This weight is declared in the ISCd, a reference file table, or similar data source.

GSRP*DFW=WSG Example formula

### SA Step 7: Combine WSG's to Create a Raw Family Score (RFS) (Step or Stage 172);

Add all WSG within group to get the RFS.

WSG₁+WSG₂+WSG₃+ . . . +WSGₙ=RFS Example formula

### SA Step 8: Convert to Usable Family Score (UFS) (Step or Stage 173);

Depending on end use, the process may convert the RFS into a more user-friendly representation of the derived score.

RFS*Desired Scoring Format Modifier (DSFM) Example formula

Example:
1. DSFM=1000
2. RFS*DSFM=UFS

### Step 5: Record Score in Data Repository (Step or Stage 174);

Generated score is sent to O (Oracle). Oracle forwards score to Data Repository.

An entry in a Data Repository is created for the derived address score. A record is kept as it facilitates faster retrieval in the future and periodic updates based on new ISC or external data. It also facilitates metrics based on historical score values.

### Step 6: Return Score to the Requesting Entity 176 (Step or Stage 175);

Generated score is sent to O 154 (Oracle). O identifies data as Score and routs score to requesting entity 176.

As a summary, in one embodiment, an example scoring algorithm described may be expressed as (using the described definitions):
1. (ISCp*DCW)/mISCp=aCS
2. aCS₁+aCS₂+aCS₃ . . . +aCSₙ=aGS
3. aGS/DGW=GSRP
4. GSRP*DFW=WSG
5. WSG₁+WSG₂+WSG₃ . . . +WSGₙ=RFS
6. Optional: RFS*DSFM=UFS

Expressed in terms of variables, the scoring algorithm takes the form:
1. (A*B)/C=D
2. D₁+D₂+D₃ . . . +Dₙ=E
3. E/F=G
4. G*H=l
5. I₁+I₂+I₃ . . . +I_{N}=J
6. Optional: J*K=L

The scoring algorithm (SA) can be considered a method of evaluating on-chain data patterns. The algorithm and its constituent components are intended to provide accurate inferences about the characteristics, behavior, and motivations of the actor associated with an address. The scoring approach uses blockchain stored transactions, which are generalized into transaction types. These represent inferences themselves and can be used to make conclusions about the characteristics, behavior, motivation of the address associated with these transactions.

These inferences can be combined with one another, creating variations or more complete representations of the actor controlling an address. For example, an address that has an on-chain pattern of frequent transactions with the meme token subset of smart contracts may mean that the actor controlling the address has an affinity for volatile tokens. This is valuable information but may be too limited to make it actionable.

To provide a more complete and reliable evaluation, one may decide to look at other on-chain transaction types and their patterns and use those to make additional inferences and combine those inferences into a more complete picture of the behavior of the address. For example, take the meme token affinity and pair it with an average value of transactions “sub-score”, then pair it further with an average Profit or Loss percentage value that triggers the address to make a buy or sell transaction. One can combine these sub-scores to create a representative score that could suggest that the actor behind the address has an affinity for meme tokens, not as a store of value, but instead as a source of quick income.

In one embodiment, a score will be presented as a numerical representation of ISC's that were compiled and run through a scoring algorithm. The score is an efficient reference or representation of a party's query result in relation to an address of interest. That query is driven by the querying party's end use of the score which itself may have complex motivations.

Consider the previously mentioned token sale where a score acts as a control mechanism to permit or deny an address's interaction with the token issuing contract. The management team for the sale has an idea of who their ideal purchaser of tokens is, that is their target customer/audience. A score that takes into consideration the characteristic(s) of their ideal customer allows for a layer of control (e.g., in terms of the execution of a contract term) that was previously unavailable. A compiled score provides information about the entity that controls an address, and data-based inferences can be made about that entity's motivations and goals. A score requester can then make an informed judgment if these goals align with their own. The score can therefore be considered a representative identity marker of the controlling entity of an address.

As another alternative, assume the hypothetical token sale management team has an ongoing token project with live buy and sale transactions on a decentralized exchange. Rather than initially controlling access to their token based on a score, they use an aggregate score, compiled from scoring all addresses interacting with their smart contract, to learn more about the addresses and entities controlling them. With this information they can implement a gating score instance that would identify/filter undesirable addresses and prevent them from being able to acquire the token.

FIG. 1(e) is a diagram illustrating a method, process, operation, or function for accessing a blockchain and obtaining data corresponding to an address for use in generating a blockchain score, in accordance with some embodiments. FIG. 1(e) exemplifies the process of acquiring important state changes (from a blockchain). If important state changes are not reflected in the Blockchain Data Repository (160), those must be acquired to facilitate score generation.

The process is initiated (159) via a lookup query that reads blockchain (162) blocks (162-1, 162-2, as examples), where the address being sought is not found in Block 162-1, and is found in Block 162-2, as non-limiting examples. For the block in which the address being sought is found, the processing identifies transactions (as suggested by 162-3) and the relevant state changes (as suggested by 162-4, 162-5, and 162-6) associated with the address. If a relevant state change is found (as suggested by 162-6), it is conceptually labelled (for the purposes of this disclosure) as an Important State Change and the data is passed to Oracle (154), and subsequently (if necessary) via RDME (164) to Blockchain Data Repository (160).

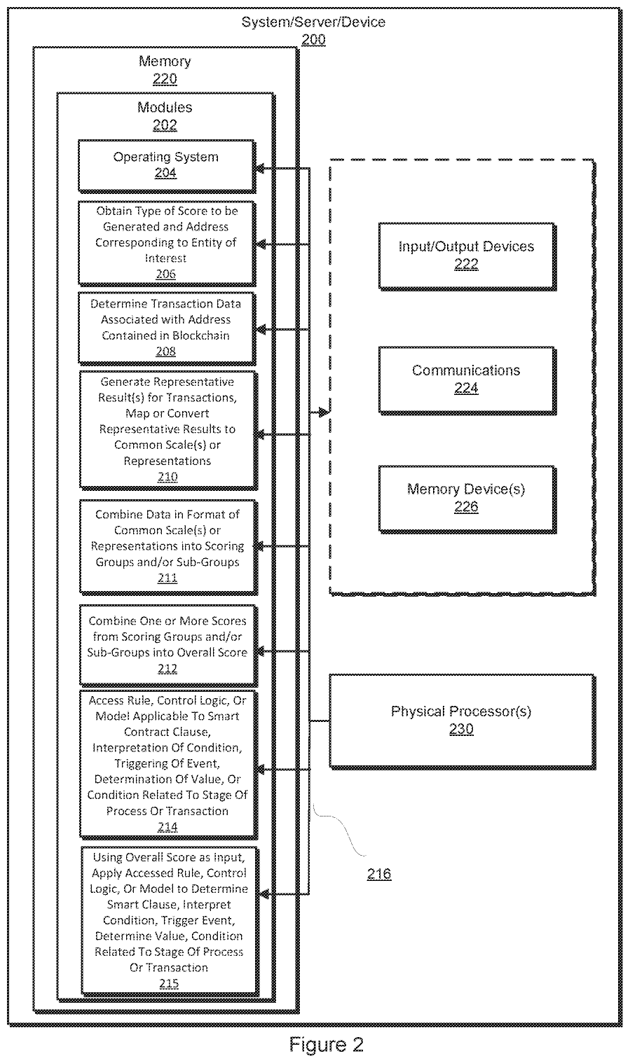

FIG. 2 is a diagram illustrating elements or components that may be present in a computer device, server, or system 200 configured to implement a method, process, function, or operation in accordance with some embodiments. As noted, in some embodiments, the described system and methods may be implemented in the form of an apparatus that includes a processing element and set of executable instructions. The executable instructions may be part of a software application and arranged into a software architecture.

In general, an embodiment of the invention may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or submodules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language,

As shown in FIG. 2, system 200 may represent a server or other form of computing or data processing device. Modules 202 each contain a set of executable instructions, where when the set of instructions is executed by a suitable electronic processor (such as that indicated in the figure by “Physical Processor(s) 230”), system (or server or device) 200 operates to perform a specific process, operation, function, or method. Modules 202 may contain one or more sets of instructions for performing a method or function described with reference to the Figures, and the descriptions of the functions and operations provided in the specification. These modules may include those illustrated but may also include a greater number or fewer number than those illustrated. Further, the modules or the computer-executable instructions that are contained in the modules may be executed (in whole or in part) by the same processor or by more than a single processor.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing a set of instructions. Bus or communications line 216 also permits processor(s) 230 to interact with other elements of system 200, such as input or output devices 222, communications elements 224 for exchanging data and information with devices external to system 200, and additional memory devices 226.

Each application module or submodule may correspond to a specific function, method, process, or operation that is implemented by the module or submodule. Each module or submodule may contain a set of computer-executable instructions that when executed by a programmed processor or processors cause the processor or processors (or a device or devices in which they are contained) to perform the specific function, method, process, or operation. Such function, method, process, or operation may include those used to implement one or more aspects of the disclosed system and methods, such as for:
Initiating a process of score generation or retrieval (may be part of instructions contained in module 206, or provided by external request and processed);
Obtaining the Type of Address Score to be Generated or Retrieved and an Address Corresponding to Entity of Interest (as suggested by module 206);
Determining Transaction Data Associated with the Address that is Contained in the Blockchain (module 208);
Generating Representative Values for Transactions, and Map or Convert Representative Values to Common Scale(s) or Representations (module 210);
Combining Data in Format of Common Scale(s) or Representations into Scoring Groups (Categories) and/or Sub-Groups (module 211);
Combining One or More Scores from Scoring Groups and/or Sub-Groups into Overall Score (module 212);
Accessing Rule, Control Logic, Or Model Applicable To Smart Contract Clause, Interpretation Of Condition, Triggering Of Event, Determination Of Value, Or Condition Related To Stage Of Process Or Transaction (module 214); and
Using Overall Score As Input, Apply Accessed Rule, Control Logic, Or Model To Determine Smart Contract Clause, Interpretation Of Condition, Triggering Of Event, Determination Of Value, Or Condition Related To Stage Of Process Or Transaction (module 215).

As mentioned, each module may contain instructions which when executed by a programmed processor cause an apparatus (such as a server or client device) perform the specific function or functions. The apparatus may be one or both of a client device or a remote server or platform. Therefore, a module may contain instructions that are performed by the client device, the server or platform, or both.

The elements, components, processes, processing stages, scoring approaches, and scoring-based logic described herein can be applied in multiple contexts and operating environments, and to assist in making a decision in almost any industry or context that is able to record information on a blockchain. As non-limiting examples, the following sections include a process flow and the associated elements or components for the following:
The generation of a score derived from blockchain data;
An implementation without the use of a Scoring Algorithm calculation;
An example Scoring Method/Algorithm; and
An example of an implementation of the described approach in the context of a Smart Contract.

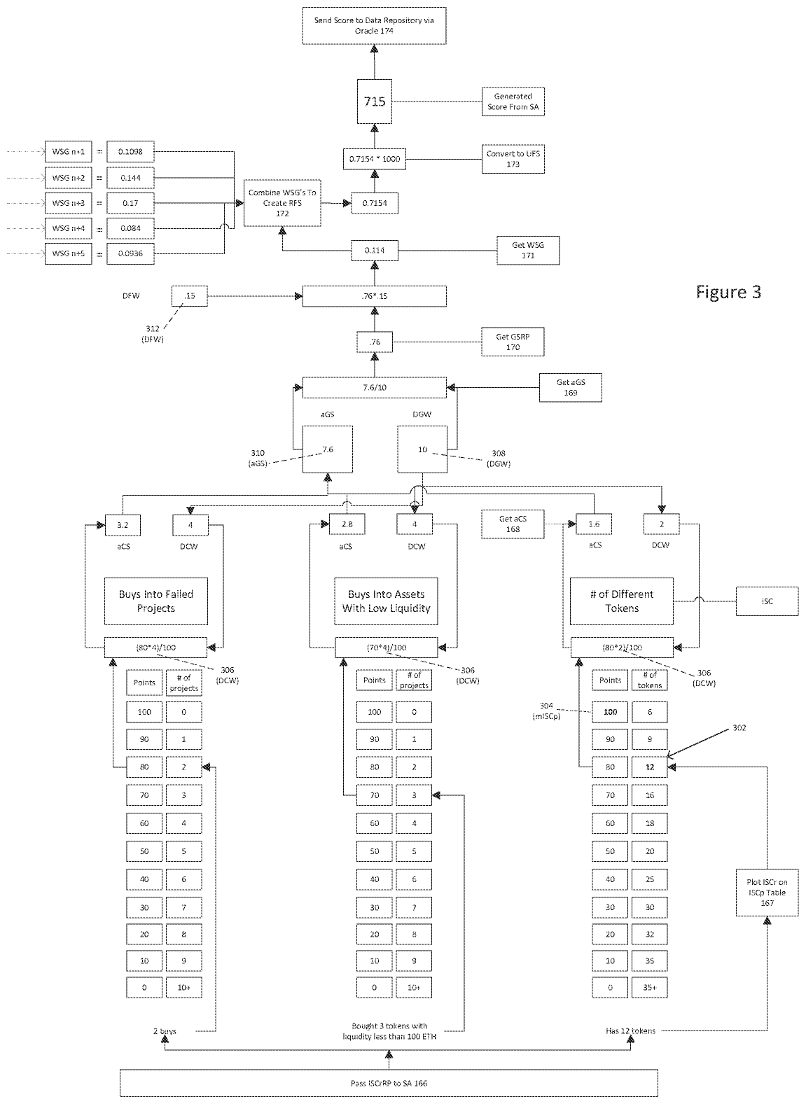

FIG. 3 is a diagram illustrating a process flow for generating a blockchain score for an entity engaged in purchasing tokens, in accordance with some embodiments. FIG. 3 illustrates a step-by-step flow of the internal operation of the Scoring Algorithm (SA) for the example use case. The Scoring Algorithm is used to process data derived from the blockchain using mathematical calculations to generate a score.

As shown in the figure, an example of the processing flow begins when a data package (ISCrRP) (element or process 166), which in certain instances can contain multiple important state change results (ISCr), is passed to the Scoring Algorithm, thus creating a first level scoring instance, termed a Component. The scoring algorithm then takes important state change results and plots them on an important state change point table to create a uniform scoring instance, resulting in translation/conversion of ISCr to ISCp.

With reference to FIG. 3, as an example, ISCr are plotted on a predetermined 0-100 ISCp table where a ISCr value of 12 is translated/converted to 80 ISCp (as indicated by data value 302 and process step, stage, or operation 167). Use of a uniform ISCp table system within a scoring instance (an execution of the scoring algorithm or process flow) allows for uniform derivative calculations. Following the ISCr to ISCp translation by process step, stage, or operation 167, the process can now derive the important state change points representative percentile (ISCrRP). The ISCrRP is generated by taking ISCp and multiplying it by the declared component weight (DCW, as indicated by data value 306) and dividing the result by the maximum number of points available (mISCp) on the ISCp Table for the particular component being worked with (in this example case this is 100, as indicated by data value 304). The resulting ISCrRP is then used to calculate the Actual Component Score (aCS) (as indicated by process step, stage, or operation 168). If for this component, the Declared Component Weight was set at 2, then an 80% ISCrRP will generate an aCS value of 1.6. This set of calculations enables the system to derive the actual score impact a component has within a grouping of components.

Component groups (or simply Groups) are an internal mechanism used in some embodiments to create a thematically similar set of components. Thematical similarity is a subjective grouping concept. For example, if one is interested in the risk tolerance of a particular party as represented by the transaction history of a wallet, one could examine or one or more of a set of characteristics. These might include (as examples): how many times the wallet conducted a transaction with a currently inactive dex (decentralized exchange) enable smart contract (failed project); how many times the wallet conducted a translation with a dex enabled smart contract that has liquidity below 100 ETH (Ethereum); and how many different tokens the wallet holds.

Within a group each component is assigned an importance value (DCW) in comparison to other components within the group. In this scoring instance/example, the mentioned components have DCW's of 4, 4 and 2 (as indicated by data values 306), cumulatively amounting to a DGW of 10 (as indicated by data value 308), respectively and aCS values of 3.2, 2.8 and 1.6 amounting to an aGS of 7.6 (as indicated by process step, stage, or operation 169 and data value 310). Similarly to when the process calculated the ISCpRP at the component level, the process now performs an aGS to percentile conversion at the group level by dividing the aGS by DGW. This produces the group's representative percentile (GSRP) value (as indicated by process step, stage, or operation 170). This percentile is representative of how well the scored address has performed within the thematic grouping that was created.

There can be a number of thematic groupings reflecting different behavior characteristics, with the one chosen depending upon the specific characteristics that it is desired the final score of an address reflect. Groupings may be based on one or more of risk tolerance, velocity of trading, value of assets, or asset holding patterns, as non-limiting examples. Each group would follow the same derivative calculations based on the inputs provided and each group having its importance within this level of hierarchy reflected by its own Declared Family Weight (DFW), that is how important that group is within a group of groups which are termed a Family herein.

Continuing with reference to FIG. 3, the risk tolerance group has a DFW value of 0.15 (as indicated by data value 312). This non-negative number that is less than 1 is used as an example to demonstrate that the use of whole numbers is not necessary, and an arbitrary user-defined number can be used in the scoring algorithm. At this stage, the processing determines how well a defined group has scored within the Family. To do this, and because a non-whole number was used as the DFW value, the process takes the GSRP value and multiplies it by the DFW value. This produces the Weighed Score of Group (WSG) within a family (as indicated by process step, stage, or operation 171).

The preceding steps can be repeated for other groups to arrive at their own individual WSG values. The WSG values are then added together to create the Raw Family Score (RFS) (as indicated by process step, stage, or operation 172). In some embodiments, the RFS is the final score the process derives, albeit in a “raw” format. This raw format can be used for the purposes of the algorithm, however there may be instances where a more convenient score is presented to the score requestor, for example where a DSFM (a score modifier, such as a multiplicative value) is applied to the generated score.

In some embodiments, a DSFM includes not only mathematical transposition but may also include appending or prepending a number or character string with machine and or human readable numbers or characters, giving more granular use case flexibility (as indicated by process step, stage, or operation 173). This generated score (a value of 715 in the example illustrated) is then sent to the Blockchain Data Repository and/or returned to the requestor (as indicated by process step, stage, or operation 174).

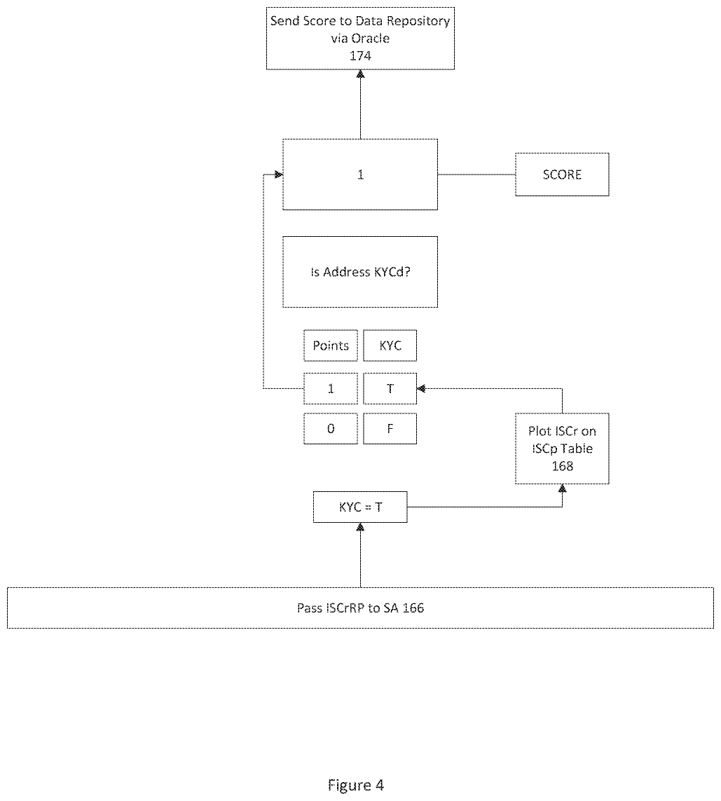

FIG. 4 is a diagram illustrating a process flow for generating data regarding the verification of an entity's address and using that information as part of a blockchain score, in accordance with some embodiments. FIG. 4 describes one of the simpler instances of the scoring algorithm; this Boolean variant of the scoring algorithm (SA) depends upon the translation of the ISCr to ISCp (as indicated by process steps, stages, or operations 166 and 168). In this instance, the process is creating an on-chain data representation based on off-chain data, and the representation is itself the score.

This simple derivation of a representative score is extremely powerful and versatile. For example, the processing flow illustrated in FIG. 4 generates a “Know Your Customer” (KYC) score. In this example use, an external identity verifier attests to a person's or entity's identity and verifies that entity's ownership/control of a particular blockchain hash (a wallet, for example). The identity verification result or “event” is communicated to the scoring algorithm as a simple Boolean result of True, meaning the hash has a verified owner. The scoring algorithm plots this Boolean result onto a 1 and 0 valued ISCp table (element or process 168), where True=1 and a No Result or False=0, and no further mathematical calculations are necessary. In this example, a score of 1 is assigned to the hash in question and this score is provided to the Data Repository via the Oracle (as indicated by process step, stage, or operation 174).

The resulting process flow provides a score that represents a verified identity of the external entity controlling a wallet. This score can be used to facilitate a Zero Knowledge Proof of identity (ZKPI) interaction on the blockchain, where a communicated score of 1 to a requesting entity signals that the hash/wallet in question has passed a KYC verification process. Although it may appear that adding a value of “False” to the ISCp table is redundant, this does serve a purpose. In score algorithm variations with multiple components, one can weigh the importance of a hash/address not being verified, and so the ability to assign a 0 or arbitrary point value to a False or No result ISCr becomes useful as it influences the derived score.

In one embodiment, a description of the process flow for the example illustrated in FIG. 4 is as follows:
1. A requestor requests a score for an address;
2. The requestor submits ISCd as part of a score request;
3. Oracle processes the request;
   a. Oracle reads the ISCd;
   b. Oracle queries the data repository for a readily available score for this ISCd;
      i. If score is available, then this score is returned to the Oracle;
         1. The Oracle passes this score back to requesting party;
      ii. If score is not available, then Oracle sends a query of each ISC stated in ISCd to the data repository;
         1. If data matching the query for the ISC and its associated address is found, then all results are put in a data return package (ISCrRP) and this data package is sent to Oracle;
         a. Oracle receives the results and passes data package to the scoring algorithm;
         2. If data matching the query for the ISC and its associated address is NOT found, then this negative result is sent to Oracle;
         a. The negative result is read by the Oracle;
         b. The Oracle sends a query for each ISC stated in ISCd to an external data source such as a blockchain index or blockchain(s) directly;
         c. Results of this query are returned to the Oracle;
         i. If data matching the query for the ISC and its associated address is found, then the results are returned to the Oracle;
         1. Oracle sends the data to the data repository to be written OR sends directly to the scoring algorithm OR both;
         ii. If data matching the query for the ISC and its associated address is NOT found, then either an error is thrown, and score cannot be generated AND/OR a score is given that considers the missing data, i.e., a representative score is given to such NIL results;
4. Scoring algorithm receives data package from Oracle;
   a. With Boolean/binary data requests the Oracle can either unpack the ISCrRP and pass the result requester immediately OR in an alternate architecture can send the ISCrRP to the Scoring Algorithm;
5. Scoring Algorithm unpacks the ISCrRP;
6. Scoring Algorithm passes the ISCr through the 1 step translation chain;
   a. The translation chain can be a simple transposition of the string, a Boolean result, or other form that is converted into a digital representation;
7. Final derived Score for address is returned to Oracle;
8. Oracle sends Score for address to be recorded in the Data Repository; and
9. Requestor receives Score.

The algorithm expressed using document definitions:
1. ISCr ISCp (optional)

The algorithm expressed using variables:

1. R->A (optional) The algorithm expressed using number into variable:

1. 1->Y (optional)

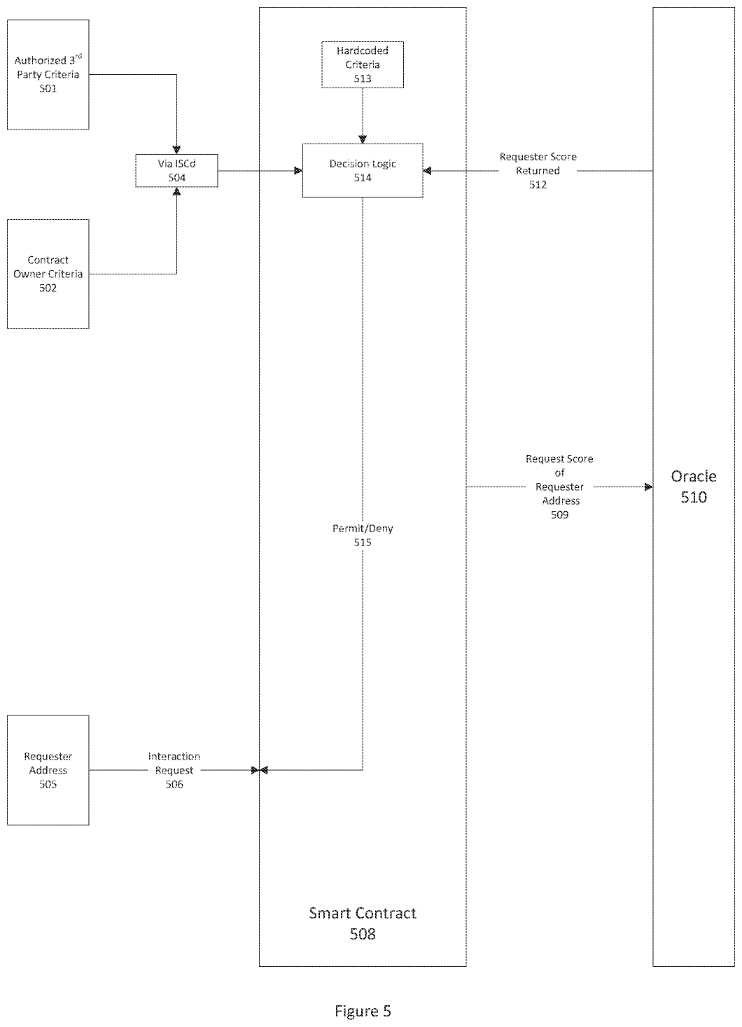

FIG. 5 is a diagram illustrating an example of how the disclosed score may be used to interact with a smart contract, in some embodiments. It is likely that many score requests will be initiated by a smart contract, and FIG. 5 illustrates an example of this situation. Smart contracts without mechanisms to effectively control who can access its functionality are vulnerable to manipulation and exploitation. This disclosure provides an example of one such control method.

A contract owner (501), contract controlling entity, or an authorized 3rd party (502) defines what information or criteria will determine a decision to permit or deny interaction with the smart contract. For example, the decision to permit or deny interaction may depend upon a requesting address having a history of frequent decentralized exchange (DEX) transactions. As an example, five (5) or more DEX transactions per week may be what the controlling entity considers as sufficient to satisfy this criterion. The criterion is communicated via an Important State Change declaration (ISCd, as suggested by element or process 504). This ISCd can be dynamically set or hard coded in the smart contract. When a request to interact (as indicated by process step, stage, or operation 506) comes from an external address (Requester Address, 505) the smart contract (indicated by element or process 508) sends a query (indicated by process step, stage, or operation 509) to the scoring Oracle (element or process 510) requesting a score that reflects the criteria passed in the ISCd (indicated by process step, stage, or operation 504).

The Oracle 510 controls the performance of the process of score generation and/or retrieval and communicates the score back to the smart contract (as indicated by process step, stage, or operation 512). Smart contract 508 “reads” the score and evaluates it against the applicable criteria using a decision process/logic (514). Decision process/logic 514 may consider criterion provided by the ISCd (504) and/or criterion that is hardcoded into the contract (as indicated by process step, stage, or operation 513) in its logical processes. If the score satisfies the threshold value, then Smart contract 508 permits interaction; if the score does not satisfy the threshold, then the interaction is denied (as indicated by process step, stage, or operation 515).

In one embodiment, a description of the process flow for the example illustrated in FIG. 5 is as follows:
1. An address requests interaction with a smart contract;
2. The smart contract receives the request;
3. The smart contract initiates conditional logic to permit or deny the interaction request;
   a. Conditional logic states what kind of score variant it uses by utilizing variable supplied ISCd;
      i. Conditional logic states that if the address has a score equal to or higher than X permit interaction, if it is lower, then deny interaction;
4. Smart contract needs to reference a score to satisfy this conditional logic;
5. Smart contract sends a request for a score to Oracle;
6. Oracle processes the request;
   a. Oracle reads the ISCd;
   b. Oracle queries the data repository for a readily available score for this ISCd;
      i. If score is available, then this score is returned to the Oracle;
         1. The Oracle passes this score back to the smart contract;
      ii. If score is not available, then Oracle sends a query of each ISC stated in ISCd to the data repository;
         1. If data matching the query for the ISC and its associated address is found, then, if necessary, data is processed by raw data manipulating equations (RDME);
         a. All resulting values are put in a data return package (ISCrRP) and this data package is sent to Oracle;
         b. Oracle receives the results and passes data package to the scoring algorithm;
         2. If data matching the query for the ISC and its associated address is NOT found, then this negative result is sent to Oracle;
         a. The negative result is read by the Oracle;
         b. The Oracle sends a query for each ISC stated in ISCd to an external data source such as a blockchain index or blockchain(s) directly;
         c. Results of this query are returned to the Oracle;
         i. If data matching the query for the ISC and its associated address is found, then the results are returned to the Oracle;
         1. If necessary, raw data is passed and processed by raw data manipulating equations;
         2. Oracle sends the results of raw data manipulating equations to the data repository to be written OR sends directly to the scoring algorithm OR both;
         ii. If data matching the query for the ISC and its associated address is NOT found, then either an error is thrown, and score cannot be generated AND/OR a score is given that considers the missing data i.e. Some component score is given to NIL results;
7. Scoring algorithm receives data package from Oracle;
8. Scoring algorithm unpacks the ISCrRP;
9. Scoring algorithm passes each ISCr through the calculation chain;
10. Final derived Score for address is returned to Oracle;
11. Oracle sends Score for address to be recorded in the Data Repository;
12. Oracle sends Score for address to requesting Smart Contract;
13. Smart Contract receives Score for address;
14. Smart Contract runs/executes conditional logic from step 3.i; and
15. Smart Contract permits or denies interaction by requesting address.

The algorithm expressed using document definitions:
1. ISCr₁->ISCp₁, ISCr₂->ISCp₂ . . . ISCrₙ->ISCpₙ
2. ISCp₁*DCW₁]/mISCp₁=aCS₁, [ISCp₂*DCW₂]/mISCp₂=aCS₂ . . . [ISCpₙ*DCWₙ]/mISCpₙ=aCSₙ
3. aCS₁+aCS₂ . . . aCSₙ=aGS₁, aCSₐ₁+aCSₐ₂ . . . ADCₐₙ=aGS₂ . . . aCSₙ+aCSₙ. . . ADCₙₙ=aGSₙ
4. aGS₁/DGW₁=GSRP₁, aGS₂/DGW₂=DGWₙ=GSRPₙ
5. GSRP₁*DFW₁=WSG₁, GSRP₂*DFW₂=WSG₂, GSRPₙ*DFWₙ=WSGₙ
6. WSG₁+WSG₂ . . . WSGₙ=RFS
7. Optional: RFS*DSFM=UFS

The algorithm expressed using variables:
1. R₁->A₁, R₂->A₂ . . . Rₙ->Aₙ
2. [A₁B₁]/C₁=D₁, [A₂*B₂]/C₂=D₂ . . . [Aₙ*Bₙ]/Cₙ=Dₙ
3. D₁+D₂+ . . . =E₁, Dₐ₁+Dₐ₂+ . . . =E₂ . . . Dₐₙ+Dₐₙ+ . . . =Eₙ
4. E₁/F₁=G₁, E₂/F₂=G₂ . . . Eₙ/Fₙ=Gₙ
5. G₁*H₁=I₁, G₂*H₂=I₂ . . . Gₙ*Hₙ=Iₙ
6. I₁+I₂ . . . Iₙ=J
7. Optional: J*K=L

The algorithm expressed using numbers (abbreviated):
1. 4->60, 180->50, 90->1 . . .
2. (60*3)/100=1.8, (50*5)/100=2.5, (90*2)/100
3. 1.8+2.5+1.8=6.1
4. 6.1/10=0.61
5. 0.61*0.18=0.1098, . . .
6. 0.1098+0.144+0.0936+0.084+0.17+0.114=0.7154
7. 0.7154*1000=715

### Example Variations of the Scoring Algorithm (SA)

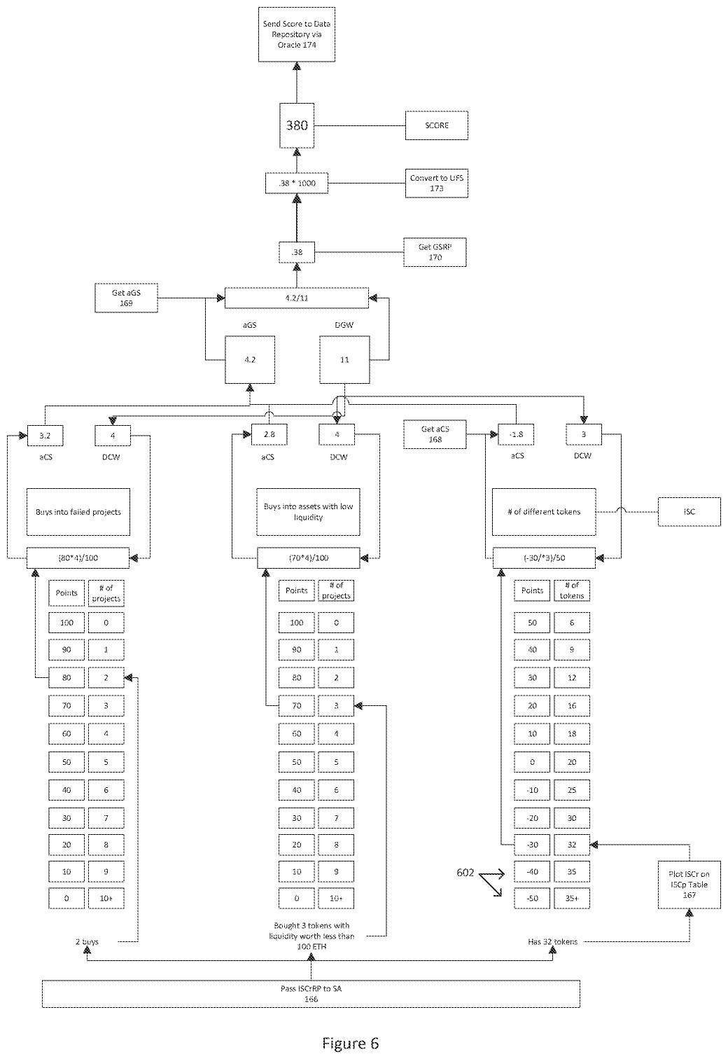

FIG. 6 is a diagram illustrating a process flow for generating a blockchain score for a situation in which a Negative ISCp Table is used, in accordance with some embodiments. ISCp Tables need not be limited to positive integers. A scoring instance may wish to “penalize” certain ISCrRP in the ultimate scoring instance. Using negative ISCp Tables allows the process to generate scoring instances where a component, group or family can have a material impact on other components, groups, or families within the residing hierarchy. In effect, this is an example of overriding the weight of a component, group, or family.

As shown in FIG. 6, ICS “# of different tokens” uses an ISCp Table with negative point values (for example, the data values/entries indicated by 602). The resulting negative ISCp can have a material effect on the aCS (168) of the component. The use of this technique allows an extension of the aCS's range below an assumed lowest sub-score of 0. A negative aCS may have a moderating or “penalizing” effect on aGS (169).

It should be noted that, employing a negative ISCp can result in negative sub-scores as the processing flows through the scoring hierarchies, ultimately resulting in an overall negative master score, if such a possibility is desired.

FIG. 6 also demonstrates the flexibility of the SA to employ varying equations to arrive at analogous results. As described with reference to FIG. 3, to obtain the aCS (168) the processing flow takes the ISCp and divides it by the mISCp (in this example, a value of 50 for this component), with the result then being multiplied by the DCW (in this example, a value of 3). This is an analogous calculation method to that of determining an aCS to one employed for the adjacent component where the ISCp (in this example, a value of 70) is multiplied by the DCW (in this example, a value of 4) and the result is then divided by the mISCp (in this example, a value of 100 for this component). This example demonstrates that the equation used to derive the aCS may be immaterial as long as the result accurately reflects ISCp as a fraction of the DCW. This holds true for other equations presented in provided examples.

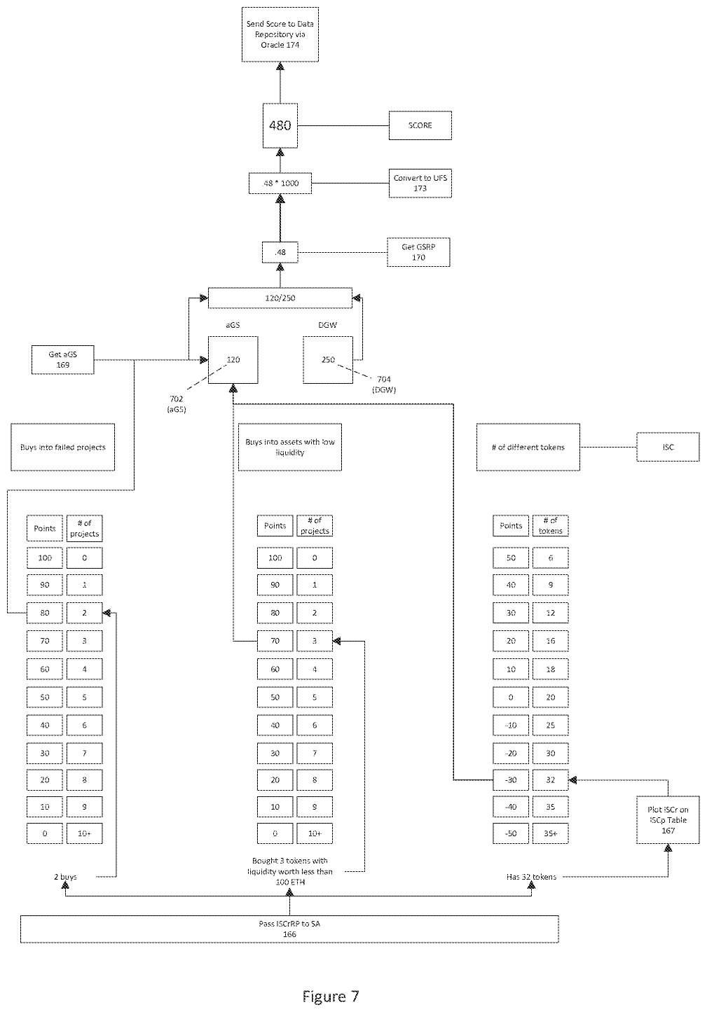

FIG. 7 is a diagram illustrating a process flow for generating a blockchain score for a situation in which an undeclared weight is used, in accordance with some embodiments. As suggested by this figure, the SA is not bound or required to use declared constants. For example, an SA variant presented in FIG. 7 does not use explicit DCWs (note the lack of a weighting factor or multiplier at the process step where the contribution of a component to the score is determined). In this example, the weight of each component is implied to be equal. This effectively means that each ISCp carries equal weight within the hierarchy. The SA example illustrated in in FIG. 7 adds ISCp together without use of a modifier (represented by the sum—30+70+80 in the example) resulting in an ISCp based aGS (as indicated by data value or process output 702). Furthermore, this also results in the creation of an implied DGW. The implied DGW in this example SA is a product of taking the component mISCp values and adding them together (as indicated by data value or process output 704). An implied weight can be used at any hierarchical level, such as component, group, family, or higher level. If appropriate, using implied weights reduces the calculation burden on the SA, as some intermediate equations, such as deriving the aCS can be eliminated.

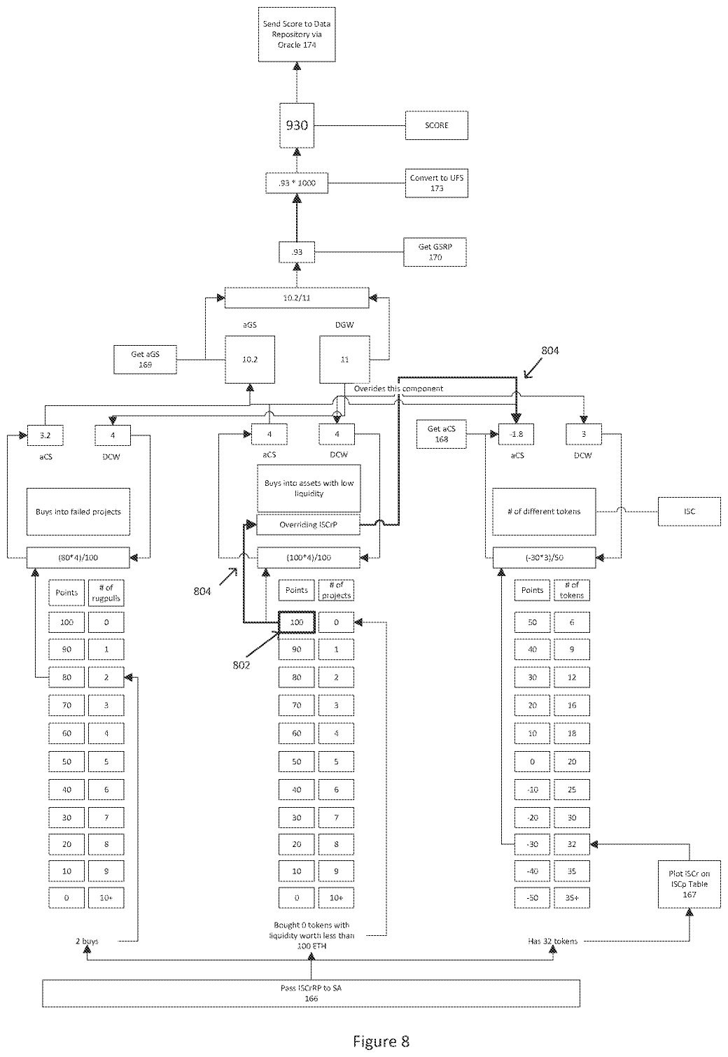

FIG. 8 is a diagram illustrating a process flow for generating a blockchain score for a situation in which a triggering event may override a step or stage of the process flow used in a scoring algorithm, in accordance with some embodiments. In one embodiment, if a certain event occurs during the scoring process, it may cause a modification in the process flow of the scoring algorithm. FIG. 8 presents a triggering event (indicated as 802 in the figure) which results in an overriding event (indicated as 804 in the figure) within the SA process flow. In this example, the triggering event is an ISCp of 100 in the “Buys into assets with low liquidity” component. As a result of this trigger, the SA overrides the aCS of component “# of different tokens”, resulting in an aCS equal to the DCW (a value of 3 in this example for that component). A triggering event can be incorporated into almost any step of the scoring process, and may be described as an “if x, then y” form of conditional.

A non-exhaustive list of scoring process events or process flow changes that a triggering event may initiate includes:
the addition of some set of variables;
the addition of an external static variable or an external variable;
discarding of a variable, component, group, or family; or
a modification of a SA constituent, where a non-exhaustive list of potentially modified constituents may include weight variables, point tables, or equations.

Although embodiments have been described with reference to regulating a commercial transaction, the techniques and methods described herein may be applied in other contexts. Scoring blockchain addresses provides a mechanism to evaluate blockchain stored data representing user behavior at a per participant granularity. The score can be used for multiple purposes and in multiple contexts. As examples, the following are further use cases, in addition to the use case of regulating or conditioning an economic transaction.

### Qualified Smart Contract Interaction

A smart contract can set a certain minimum score criteria to permit someone to buy a token, with a person's score determined by evaluation of a person's blockchain data, particularly their data related to experience with purchasing tokens, types of tokens previously purchased, or holding periods, as examples. A smart contract may set a threshold value and any address that attempts to initiate a buy is denied if their score falls below the set value.

### Advertising (Qualified display of data)

A score can be used as part of a process to target a specific audience. A web service that requires users to log in by connecting their wallet can use the score of the connected wallet to decide the advertising content to serve. Advertisers can declare the type of behavior they seek as an audience for content. For example, they may want to present content to frequent participants in low value transactions. Based on this declaration, a score that reflects frequent low value transactions can be used to determine who is served the advertisers messaging.

### Credit Scoring (Ranking)

Based on on-chain behavior a credit score can be issued to a wallet. Additionally, a financial credit scoring agency can incorporate the described blockchain score into the formula from which their credit score is derived. This is an example of bridging on-chain and off-chain behavior and creating a hybrid scoring mechanism.

A credit score or rating can be derived for smart contracts and/or organizations using smart contracts or the blockchain as an underlying operational technology (DAO—Decentralized autonomous organizations or Token/Coin based projects, as examples). In addition, as the regulatory framework surrounding blockchain matures, blockchain derived assets are increasingly likely to be classified as securities (at least for some use cases or contexts), making issuing entities subject to security offering/trading regulations. The scoring mechanism(s) disclosed herein may be used as part of a process to evaluate behaviors within such environments and/or assist regulatory agencies to track and monitor behaviors to ensure compliance with relevant rules and regulations.

### Incentivizing Behavior (Conditioning)

A party that desires to incentivize a certain behavior can set a score to be achieved by the parties that it wishes to influence. These parties are encouraged to follow a set pattern of behaviour to reach the score or target and receive the benefit from the party setting the score value.

### Off-Chain Commercial Interactions

Customer-to-Customer (C2C), Business-to-Customer (B2C), and Business-to-Business (B2B) interactions can be moderated by incorporating the score into a process to permit, deny, or allow a qualified permit/deny for a transaction. For example, offering goods and services to clients that meet a desired score threshold value.

### Finance

A lender/investor can incorporate the score into their risk analysis algorithms. The score may be used to influence the lending/investing terms offered to a requesting party.

### Regulation

As governments consider use of Central Bank Digital Currencies (CBDCs), the disclosed scoring approach may enable regulatory entities to monitor and assess CBDC holders, enabling regulatory policy development/changes to fit real world usage statistics.

### Performance Assessment

For example, medical practitioner performance records kept on a blockchain could be scored and any anomalies would be made more clearly identifiable and addressable. Performance scoring can also be employed with physical goods, such as critical car components, where blockchain recorded problems can be evaluated and scored using a version of the proposed scoring mechanism.

### NFTs

Non-Fungible tokens are smart contracts or the products thereof and can be evaluated and scored by leveraging on-chain data. This may range from trading history scores (such as where velocity of transfers is evaluated), to more complex scoring based on NFT characteristics in relation to the market desirability of those characteristics.

### Decentralized Blockchain Gaming

In decentralized gaming, variants of the disclosed scoring algorithm can be used to evaluate in game aggregate or individual actions and combine them into a generated meta score or individual granular scores.

### Metaverses

In instances of real/digital world hybrids such as AR driven Metaverses where blockchain is part of the technology employed, scoring of state changes is also applicable. Transactions, assets, or entities in such metaverses can be assessed via their associated and recorded chain data and issued a score, with the score then used by participants or in-world processes to make a decision.

### Identification

KYC, ZKPI and other identification related uses where an entity's verified identity status can be reduced, using the proposed methods, to a score variable are not limited to single criterion examples. A score can reflect different levels of verification, thus enabling greater granularity. A score of an address that reflects verification of identity papers could be different then the score of an address that reflects verification of identity papers and a confirmation of residential address details, for example.

### Data Analytics

An assigned wallet score facilitates aggregation of anonymized on-chain activity data. For example, a scoring instance can be run against all wallets that interacted with a smart contract. The returned scores represent a representative profile of the interacting parties, as well as identifying those parties by their addresses. Both sets of information may have uses to other entities for purposes of advertising, promotion, providing services, or regulation, as examples.

### Security

Monitoring or scanning blockchains for scores that reflect interactions with questionable entities using the disclosed scoring approaches may also be possible and facilitates flagging or indicating suspicious activity, and qualified flagging based on a supplied severity index. For example, interaction with crypto mixing services, known money/crypto laundering offramps such as bullion for crypto entities, or sanctioned exchanges or banks, could be used to generate a specific type of score that would be communicated to a monitoring entity for further investigation.

Further, the described scoring method or algorithm can be modified to incorporate other factors (other types of blockchain data) and data processing rules. Multiple types of scores may be created using varying ISC, modifiers, and data sources depending on the intended use. External (off-blockchain) factors can also be used to combine, append to, or change a score or its algorithm. As non-limiting examples:
A metric formed from a combined Score+Home Ownership Status;
A metric formed from a combined Score+Citizenship status;
A metric formed from an appended Score+Net Worth;
A metric formed from a combined Score+Employee Count;
A metric formed from an appended Score+Internet Browsing History;
A metric formed from a modified score based on off-chain Identity Verification; or
A metric formed from a combined Score+other off chain factor,

In some embodiments, the disclosed scoring algorithm can be modified. For example, variables can be inserted, removed, or modified as decided upon by the score requester. These changes can be triggered by on-chain and off-chain events. Non-limiting examples of such triggers are:
Machine learning (ML) triggered updates of the steps to derive a score based on industry specific use cases. For example, if a score requester is identified by an ML process to be in the financial industry, then this might trigger the inclusion of financial industry specific changes to the scoring algorithm, such as the use of variable weight components, or use of a specific ISC such as Address Age;
Fluid inputs such as commodity prices that are representative of non-static variables; or
Current metrics found in blockchain services focus on evaluating smart contracts, and in particular, smart contracts that issue tokens or coins as means of exchange and/or investment. This represents a focus on factors such as available liquidity, price, number of holders, and the circulating and fully diluted market capitalization of the smart contract and its issued token. While useful, this is a very narrow and limited approach to a data-based understanding of blockchain participants, and their corresponding value, quality, desirability, utility, or veracity, as examples.

The disclosed score or index is a mechanism/method of categorizing, profiling, ranking, and segmenting/grouping blockchain hashes (addresses) based on their activity, thereby allowing the assignment of a score based on that activity from data retrieved from a blockchain record(s). In one sense, the described scoring system shifts the focus from tokens and smart contracts to blockchain hashes that represent individual blockchain wallets, where the described scoring system can be applied to any address on the blockchain (which would include smart contracts as well).

The disclosure includes the following clauses and embodiments:
1. A method, comprising:
obtaining a blockchain address;
determining a set of transactions associated with the address that are recorded on the blockchain;
processing data obtained from the blockchain to generate a representative value for each of the set of transactions;
mapping or converting the representative value for each of the set of transactions to a standardized representation;
combining one or more of the standard representations into a group score, sub-group score, or an overall score associated with the address;
based on the group score, sub-group score, or overall score, determining if a condition related to a stage of a process or transaction is satisfied;
if the condition is satisfied, then performing the stage of the process or transaction; and
if the condition is not satisfied, then not performing the stage of the process or transaction.
2. The method of clause 1, wherein determining if a condition related to a stage of a process or transaction is satisfied further comprises:
accessing a rule-set, control logic, or model that uses the group score, sub-group score, or overall score as an input; and
based on the rule-set, control logic, or model and the group score, sub-group score, or overall score, determining if the condition related to the stage of the process or transaction is satisfied.
3. The method of clause 1, wherein the process or transaction is one of a token purchase, an agreement to purchase a product or service, a selection of content to present to an entity in control of the address, an event in a gaming environment, an assessment of a performance, or the approval or disapproval of an output of the process.
4. The method of clause 3, wherein the condition related to the stage of the process or transaction is determined by a smart contract.
5. The method of clause 1, wherein determining if a condition related to a stage of a process or transaction is satisfied further comprises:
combining the group, sub-group, or overall score and one or more factors associated with the address into a total score; and
using the total score to determine if the condition is satisfied.
6. The method of clause 5, wherein the one or more factors associated with the address comprise home ownership status, citizenship status, net worth, employee count, Internet browsing history, or a result of an off-chain identity verification.
7. The method of clause 1, wherein determining if a condition related to a stage of a process or transaction is satisfied further comprises determining if the group score, sub-group score, or overall score exceeds a predetermined value.
8. A system, comprising:
one or more electronic processors configured to execute a set of computer-executable instructions; and
the set of computer-executable instructions, wherein when executed, the instructions cause the one or more electronic processors to
   obtain a blockchain address;
   determine a set of transactions associated with the address that are recorded on the blockchain;
   process data obtained from the blockchain to generate a representative value for each of the set of transactions;
   map or convert the representative value for each of the set of transactions to a standardized representation;
   combine one or more of the standard representations into a group score, sub-group score, or an overall score associated with the address;
   based on the group score, sub-group score, or overall score, determine if a condition related to a stage of a process or transaction is satisfied;
   if the condition is satisfied, then perform the stage of the process or transaction; and
   if the condition is not satisfied, then not perform the stage of the process or transaction.
9. The system of clause 8, wherein determining if a condition related to a stage of a process or transaction is satisfied further comprises:
accessing a rule-set, control logic, or model that uses the group score, sub-group score, or overall score as an input; and
based on the rule-set, control logic, or model and the group score, sub-group score, or overall score, determining if the condition related to the stage of the process or transaction is satisfied.
10. The system of clause 8, wherein the process or transaction is one of a token purchase, an agreement to purchase a product or service, a selection of content to present to an entity in control of the address, an event in a gaming environment, an assessment of a performance, or the approval or disapproval of an output of the process.
11. The system of clause 8, wherein the condition related to the stage of the process or transaction is determined by a smart contract.
12. The system of clause 8, wherein determining if a condition related to a stage of a process or transaction is satisfied further comprises:
combining the group, sub-group, or overall score and one or more factors associated with the address into a total score; and
using the total score to determine if the condition is satisfied.
13. The system of clause 12, wherein the one or more factors associated with the address comprise home ownership status, citizenship status, net worth, employee count, internet browsing history, or a result of an off-chain identity verification.
14. The system of clause 8, wherein determining if a condition related to a stage of a process or transaction is satisfied further comprises determining if the group score, sub-group score, or overall score exceeds a predetermined value.
15. A set of computer-executable instructions that when executed by one or more programmed electronic processors, cause the processors to:
obtain a blockchain address;
determine a set of transactions associated with the address that are recorded on the blockchain;
process data obtained from the blockchain to generate a representative value for each of the set of transactions;
map or convert the representative value for each of the set of transactions to a standardized representation;
combine one or more of the standard representations into a group score, sub-group score, or an overall score associated with the address;
based on the group score, sub-group score, or overall score, determine if a condition related to a stage of a process or transaction is satisfied;
if the condition is satisfied, then perform the stage of the process or transaction; and
if the condition is not satisfied, then not perform the stage of the process or transaction.
16. The set of computer-executable instructions of clause 15, wherein determining if a condition related to a stage of a process or transaction is satisfied further comprises:
accessing a rule-set, control logic, or model that uses the group score, sub-group score, or overall score as an input; and
based on the rule-set, control logic, or model and the group score, sub-group score, or overall score, determining if the condition related to the stage of the process or transaction is satisfied.
17. The set of computer-executable instructions of clause 15, wherein the process or transaction is one of a token purchase, an agreement to purchase a product or service, a selection of content to present to an entity in control of the address, an event in a gaming environment, an assessment of a performance, or the approval or disapproval of an output of the process.
18. The set of computer-executable instructions of clause 15, wherein the condition related to the stage of the process or transaction is determined by a smart contract.
19. The set of computer-executable instructions of clause 15, wherein determining if a condition related to a stage of a process or transaction is satisfied further comprises:
combining the group, sub-group, or overall score and one or more factors associated with the address into a total score; and
using the total score to determine if the condition is satisfied.
20. The set of computer-executable instructions of clause 19, wherein the one or more factors associated with the address comprise home ownership status, citizenship status, net worth, employee count, internet browsing history, or a result of an off-chain identity verification.
21. The set of computer-executable instructions of clause 15, wherein determining if a condition related to a stage of a process or transaction is satisfied further comprises determining if the group score, sub-group score, or overall score exceeds a predetermined value.
22. The method of clause 2, wherein the model is a trained machine learning model.
23. The method of clause 1, wherein mapping or converting the representative value for each of the set of transactions to a standardized representation or combining one or more of the standard representations into a group score, sub-group score, or an overall score associated with the address is performed using a trained model.
24. The method of clause 7, wherein the predetermined value is determined by a trained model.
25. The system of clause 9, wherein the model is a trained machine learning model.
26. The system of clause 8, wherein mapping or converting the representative value for each of the set of transactions to a standardized representation or combining one or more of the standard representations into a group score, sub-group score, or an overall score associated with the address is performed using a trained model.
27. The system of clause 14, wherein the predetermined value is determined by a trained model.
28. The set of computer-executable instructions of clause 16, wherein the model is a trained machine learning model.
26. The set of computer-executable instructions of clause 15, wherein mapping or converting the representative value for each of the set of transactions to a standardized representation or combining one or more of the standard representations into a group score, sub-group score, or an overall score associated with the address is performed using a trained model.
27. The set of computer-executable instructions of clause 21, wherein the predetermined value is determined by a trained model,

It should he understood that the present invention as described above can he implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method, comprising:
obtaining a blockchain address;
determining a set of transactions associated with the address that are recorded on the blockchain;
processing data obtained from the blockchain to generate a representative value for each of the set of transactions;
mapping or converting the representative value for each of the set of transactions to a standardized representation;
combining one or more of the standard representations into a group score, sub-group score, or an overall score associated with the address;
based on the group score, sub-group score, or overall score, determining if a condition related to a stage of a process or transaction is satisfied;
if the condition is satisfied, then performing the stage of the process or transaction; and
if the condition is not satisfied, then not performing the stage of the process or transaction.

2. The method of claim 1, wherein determining if a condition related to a stage of a process or transaction is satisfied further comprises:
accessing a rule-set, control logic, or model that uses the group score, sub-group score, or overall score as an input; and
based on the rule-set, control logic, or model and the group score, sub-group score, or overall score, determining if the condition related to the stage of the process or transaction is satisfied.

3. The method of claim 1, wherein the process or transaction is one of a token purchase, an agreement to purchase a product or service, a selection of content to present to an entity in control of the address, an event in a gaming environment, an assessment of a performance, or the approval or disapproval of an output of the process.

4. The method of claim 3, wherein the condition related to the stage of the process or transaction is determined by a smart contract.

5. The method of claim 1, wherein determining if a condition related to a stage of a process or transaction is satisfied further comprises:
combining the group, sub-group, or overall score and one or more factors associated with the address into a total score; and
using the total score to determine if the condition is satisfied.

6. The method of claim 5, wherein the one or more factors associated with the address comprise home ownership status, citizenship status, net worth, employee count, internee browsing history, or a result of an off-chain identity verification.

7. The method of claim 1, wherein determining if a condition related to a stage of a process or transaction is satisfied further comprises determining if the group score, sub-group score, or overall score exceeds a predetermined value.

8. A system, comprising:
one or more electronic processors configured to execute a set of computer-executable instructions; and
the set of computer-executable instructions, wherein when executed, the instructions cause the one or more electronic processors to
obtain a blockchain address;
determine a set of transactions associated with the address that are recorded on the blockchain;
process data obtained from the blockchain to generate a representative value for each of the set of transactions;
map or convert the representative value for each of the set of transactions to a standardized representation;
combine one or more of the standard representations into a group score, sub-group score, or an overall score associated with the address;
based on the group score, sub-group score, or overall score, determine if a condition related to a stage of a process or transaction is satisfied;
if the condition is satisfied, then perform the stage of the process or transaction; and
if the condition is not satisfied, then not perform the stage of the process or transaction.

9. The system of claim 8, wherein determining if a condition related to a stage of a process or transaction is satisfied further comprises:
accessing a rule-set, control logic, or model that uses the group score, sub-group score, or overall score as an input; and
based on the rule-set, control logic, or model and the group score, sub-group score, or overall score, determining if the condition related to the stage of the process or transaction is satisfied.

10. The system of claim 8, wherein the process or transaction is one of a token purchase, an agreement to purchase a product or service, a selection of content to present to an entity in control of the address, an event in a gaming environment, an assessment of a performance, or the approval or disapproval of an output of the process.

11. The system of claim 8, wherein the condition related to the stage of the process or transaction is determined by a smart contract.

12. The system of claim 8, wherein determining if a condition related to a stage of a process or transaction is satisfied further comprises:
combining the group, sub-group, or overall score and one or more factors associated with the address into a total score; and
using the total score to determine if the condition is satisfied.

13. The system of claim 12, wherein the one or more factors associated with the address comprise home ownership status, citizenship status, net worth, employee count, internet browsing history, or a result of an off-chain identity verification.

14. The system of claim 8, wherein determining if a condition related to a stage of a process or transaction is satisfied further comprises determining if the group score, sub-group score, or overall score exceeds a predetermined value.

15. A set of computer-executable instructions that when executed by one or more programmed electronic processors, cause the processors to:
obtain a blockchain address;
determine a set of transactions associated with the address that are recorded on the blockchain;
process data obtained from the blockchain to generate a representative value for each of the set of transactions;
map or convert the representative value for each of the set of transactions to a standardized representation;
combine one or more of the standard representations into a group score, sub-group score, or an overall score associated with the address;
based on the group score, sub-group score, or overall score, determine if a condition related to a stage of a process or transaction is satisfied;
if the condition is satisfied, then perform the stage of the process or transaction; and
if the condition is not satisfied, then not perform the stage of the process or transaction.

16. The set of computer-executable instructions of claim 15, wherein determining if a condition related to a stage of a process or transaction is satisfied further comprises:
accessing a rule-set, control logic, or model that uses the group score, sub-group score, or overall score as an input; and
based on the rule-set, control logic, or model and the group score, sub-group score, or overall score, determining if the condition related to the stage of the process or transaction is satisfied.

17. The set of computer-executable instructions of claim 15, wherein the process or transaction is one of a token purchase, an agreement to purchase a product or service, a selection of content to present to an entity in control of the address, an event in a gaming environment, an assessment of a performance, or the approval or disapproval of an output of the process.

18. The set of computer-executable instructions of claim 15, wherein the condition related to the stage of the process or transaction is determined by a smart contract.

19. The set of computer-executable instructions of claim 15, wherein determining if a condition related to a stage of a process or transaction is satisfied further comprises:
combining the group, sub-group, or overall score and one or more factors associated with the address into a total score; and
using the total score to determine if the condition is satisfied.

20. The set of computer-executable instructions of claim 19, wherein the one or more factors associated with the address comprise home ownership status, citizenship status, net worth, employee count, internet browsing history, or a result of an off-chain identity verification.
